(19) United States
(12) Patent Application Publication
(10) Pub. No.: US 2015/0212710 A1
(43) Pub. Date: Jul. 30, 2015

(54) CARD INTERFACE FOR MANAGING DOMAIN SEARCH RESULTS

(71) Applicant: Go Daddy Operating Company, LLC, Scottsdale, AZ (US)

(72) Inventors: Nitin Gupta, Mountain View, CA (US); Edward J. Karcher, III, Chandler, AZ (US); Garrett Matsudaira, Bellevue, WA (US)

(21) Appl. No.: 14/683,485

(22) Filed: Apr. 10, 2015

Related U.S. Application Data
(63) Continuation-in-part of application No. 14/524,898, filed on Oct. 27, 2014.
Application No. 14/524,898 is a continuation-in-part of application No. 14/504,034, filed on Oct. 1, 2014.
Application No. 14/504,034 is a continuation-in-part of application No. 14/504,200, filed on Oct. 1, 2014.
Application No. 14/504,200 is a continuation-in-part of application No. 14/051,358, filed on Oct. 10, 2013.

(51) Int. Cl. G06F 3/0484; G06Q 30/06; G06F 3/0482

(52) U.S. Cl. CPC G06F 3/04842; G06F 3/0482; G06Q 30/0641

(57) ABSTRACT

Methods are provided to display a plurality of candidate domain names identified in a domain name search in a manageable user interface. The user interface displays the candidate domain names on cards that can be interacted with to display information about the candidate domain names, store the candidate domain names for later review, and purchase the candidate domain names. The user interface enables the purchase of a candidate domain name directly from a list of domain search results.

### CROSS-REFERENCE TO RELATED APPLICATIONS

This application is a continuation-in-part and claims the benefit of U.S. patent application Ser. No. 14/524,898, entitled “CARD INTERFACE FOR MANAGING DOMAIN NAME PROJECTS” and filed Oct. 27, 2014, which is a continuation-in-part claiming the benefit of U.S. patent application Ser. No. 14/504,034, entitled “SYSTEM AND METHOD FOR MANAGING DOMAIN NAME PROJECTS” and filed Oct. 1, 2014, and this application is a continuation-in-part and claims the benefit of U.S. patent application Ser. No. 14/504,200, entitled “SYSTEM AND METHOD FOR PRESENTATION OF CANDIDATE DOMAIN NAME STACKS IN USER INTERFACE” and filed Oct. 1, 2014, which is a continuation-in-part claiming the benefit of U.S. patent application Ser. No. 14/051,358, entitled “CANDIDATE DOMAIN NAME GENERATION” and filed Oct. 10, 2013, the entirety of which are incorporated herein by reference.

### FIELD OF THE INVENTION

The present invention generally relates to domain names, and, more specifically, to methods for sorting a plurality of domain names.

### BACKGROUND OF THE INVENTION

For Internet users and businesses alike, the Internet continues to be increasingly valuable. More people use the Web for everyday tasks, from social networking, shopping, banking, and paying bills to consuming media and entertainment. E-commerce is growing, with businesses delivering more services and content across the Internet, communicating and collaborating online, and inventing new ways to connect with each other. With this increased popularity and value comes an increased desire for websites and web service providers to procure multiple domain names that may be related to their website, web service, brand, or product. Further, as domain names have become more valuable, many domain name speculators and brokers have amassed vast numbers of domain names. As individuals and entities procure more and more domain names, it can become increasingly difficult for the individual or entity to manage or otherwise keep track of the plurality of domain names that they own or have an interest in. Additionally, these users or entities may have little time to organize a portfolio of domain names.

Domain names are valuable in part because they are exhaustive: there can be only one of each domain name (e.g., “example.com”) having a certain top level domain (TLD) (i.e., the “.com” of the above example) and a certain second level domain (SLD) (i.e., the “example” of the above example). The entities procuring domain names use a domain search to check whether the domain they want is available. Most domain search engines will then suggest domain names that are similar to the search terms, creating variations on the SLD and appending the variations to different TLDs. There can be many search engine results pages (SERPs) presented to the entity by the domain search engine. Each SERP lists the suggested domain names but it can be difficult to convey other information or purchasing/registration options on the SERP. An intuitive method of presenting domain search results is needed.

### BRIEF DESCRIPTION OF THE DRAWINGS

FIG. 1 is a schematic diagram of a server and associated contextual operating environment in accordance with various embodiments of the present disclosure.

FIG. 2 is a functional schematic diagram of a method in accordance with the various embodiments of the present disclosure.

FIGS. 3 and 4 are example visual depictions of the method in accordance with the various embodiments of the present disclosure.

FIG. 5 is a functional schematic diagram of an alternative method in accordance with various embodiments.

FIG. 6 is a functional schematic diagram of another alternative method in accordance with various embodiments.

FIGS. 7-9 are diagrams of a user interface displaying tactile domain name cards on a screen layout in accordance with various embodiments of the disclosure.

FIG. 10 is a flowchart depicting a method of presenting candidate domain names in a user interface in accordance with the disclosure.

FIGS. 11A-14 are diagrams of a mobile device user interface displaying tactile domain name cards on a screen layout in accordance with various embodiments of the disclosure.

### DETAILED DESCRIPTION OF THE PREFERRED EMBODIMENT

The present invention overcomes the aforementioned drawbacks by providing methods and systems for sorting a plurality of domain names. By implementing the disclosed domain name sorting methods, users are able to easily keep track of a plurality of domain names grouped by projects in a hierarchal manner. Although useful with any number of domain names, the disclosed methods become particularly more useful when the number of domain names and/or number of projects increases. Further, in some embodiments, sorting can occur automatically thereby reducing or eliminating the amount of time a user must spend to organize a portfolio of domain names.

In one implementation, the present disclosure describes a method including sorting by a computing device a plurality of domain names into a plurality of projects to create a sorted plurality of domain names. In one embodiment, the plurality of domain names are each associated with a same user account. The method further includes storing the sorted plurality of domain names as part of the user account.

In another embodiment, the present disclosure describes a server device that is configured to sort a plurality of domain names into a plurality of projects to create a sorted plurality of domain names. In one embodiment, the plurality of domain names are each associated with a same user account. The server is further configured to store the sorted plurality of domain names as part of the user account.

In another embodiment, the present disclosure describes a method performed by a computer server in electronic communication with a computer network. The method includes presenting to a user, via a graphical user interface (GUI) on a display device in electronic communication with the computer network, one or more cards on a screen layout, the cards each having a graphical representation of data pertaining to a domain name in an account of the user. The GUI enables the user to perform one or more interactions on the cards. The graphical representation of one or more of the cards may include a front of the card and a back of the card; one of the interactions may be enabling the user to flip the card so that the front or the back of the card is displayed. The front of the card may include the domain name to which the card pertains, and may further include one or more functional properties of the domain name. The functional properties included on the front of the card may include one or more of a domain summary, one or more indicators of an applied service, and an auto-renewal setting. The front of the card may further include one or more prompts selectable by the user to perform one or more of the interactions. The prompts may include a “flip” icon that, when selected, causes the card to flip from the front of the card to the back of the card on the GUI.

The back of the card may include a content pane that displays one or more functional properties of the domain name and/or one or more traffic statistics of the domain name. The back of the card may further include a navigation menu selectable by the user to cause different of the functional properties to be displayed in the content pane when selected. The back of the card may include one or more prompts selectable by the user to perform one or more of the interactions. The prompts may include a “flip” icon that, when selected, causes the card to flip from the back of the card to the front of the card on the GUI. The GUI may display a plurality of the cards on the screen layout, and two or more of the cards may be displayed in a stack when the domain names of each of the cards in the stack are grouped in a project in the account of the user.

The method may further include receiving interaction data describing a performed interaction of the interactions, and modifying one or more functional properties of the domain name associated with one or more of the cards involved in the performed interaction. The interactions may include one or more of dragging one of the cards onto another of the cards, dragging a stack comprising a plurality of the cards onto another of the cards not in the stack, flipping one of the cards, and shuffling the cards. When the performed interaction is dragging a first of the cards onto a second of the cards, modifying the one or more properties of the domain name may involve forwarding traffic to the domain name of the first card to the domain name of the second card. When the performed interaction is dragging the stack onto another of the cards not in the stack, modifying the one or more properties of the domain name may involve changing a resource record of the domain name of each of the cards in the stack to match a resource record of the domain name of the card not in the stack.

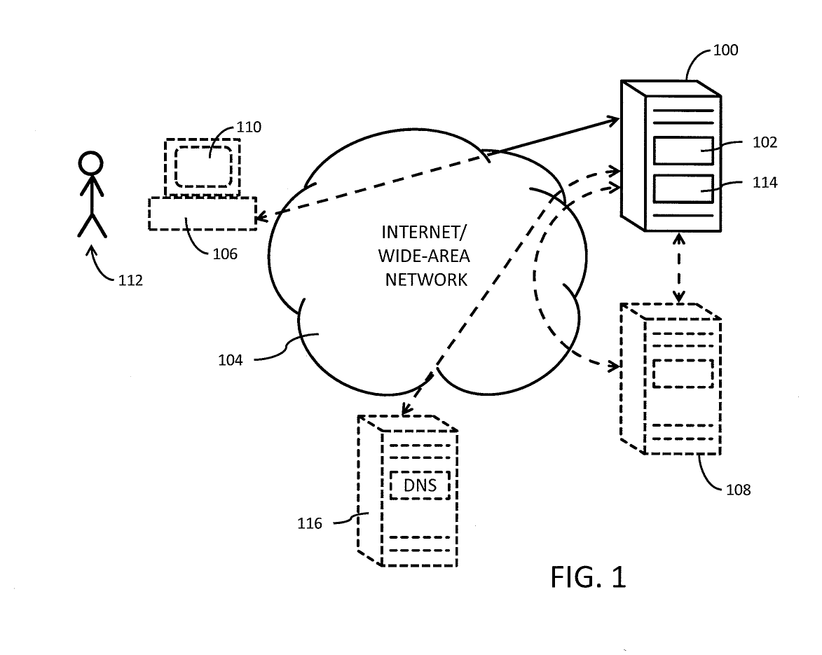

Referring first to FIG. 1, an example contextual environment for implementation of the disclosed methods is illustrated. A server 100 (e.g., a server device, a network server, a web server, a computer server, or the like) may include one or more processing devices 102 (such as one or more central processors) and may include or be communicatively coupled to a network interface. The network interface may in turn be communicatively coupled to a wide-area network such as the Internet 104 thereby coupling the server 100 to the World Wide Web. The server 100 may be one of many servers, for example, as part of a server farm configured to service a large number of client devices 106. A plurality of servers may be communicatively coupled together through a network with other control computers configured to control aspects of the servers and to route communications to and from the servers. In certain embodiments, the server 100 may be communicatively coupled to one or more second servers 108. The second server 108 may in certain embodiments operate together with the first server 100 to provide a web service (e.g., a web resource, website, webpage, or the like). In certain embodiments, the first server 100 and the second server 108 (or any other servers) may be owned, operated, and/or managed by a single entity. Additionally, although the servers 100, 108 are depicted and described as separate hardware entities, in certain embodiments the servers may be the same single server implementing multiple web services. In other embodiments, the first server 100 and the second server 108 (or any other servers) may be owned, operated, and/or managed by separate entities. These separate entities may co-operate through various agreements to provide the web resources (for example, a fee may be provided to access and use the second web resource).

In one embodiment, the server 100 is configured to communicatively couple to a client device 106 through the network interface and the Internet 104 to provide a user interface (such as a graphical user interface or GUI) to search for, procure, buy, sell, register, research, and/or manage one or more domain names. Communications between the server 100 and the client device 106 may be achieved using any electronic communication medium, communication protocol, and computer software suitable for transmission of data over the Internet 104. Examples include, respectively and without limitation: a wired connection, WiFi or other wireless network, cellular network, or satellite network; Transmission Control Protocol and Internet Protocol (“TCP/IP”), Global System for mobile Communications (“GSM”) protocols, code division multiple access (“CDMA”) protocols, and Long Term Evolution (“LTE”) mobile phone protocols; web browsers such as MICROSOFT INTERNET EXPLORER, MOZILLA FIREFOX, and APPLE SAFARI; and other client-executable software modules.

The client device 106 may comprise various computing devices such as, for example, a desktop computer, a laptop computer, a tablet, a smart phone, other network servers, or any other electronic device capable of communicating with the server 100 over the Internet 104. Such a client device 106 may include one or more processing devices, display devices 110, user interfaces, and/or network interfaces. Typically, though not always, the client device 106 is utilized by a user 112 to access the server 100 or a service provided by the server 100. In various embodiments, a user 112 utilizes the client device 106 to access a domain name management user account provided by the server 100 via the Internet 104. The user 112 may be an individual, a group of individuals, a business or other organization, or any other entity that desires to search for, procure, buy, sell, register, research, and/or manage domain names, whether the intent is commercial or non-commercial in nature.

The server 100 may include or be configured to communicate electronically with one or more data stores 114 in order to retrieve information from or store information to the data store 114. In some embodiments, a data store 114 may be a component of the server 100, such as, for example, a memory device of the server 100, or communicatively coupled to the server 100 (such as a memory module or a disk drive). In other embodiments, a data store 114 may be part of a different server (e.g., the second server 108), or as part of a different network-accessible data store. Electronic communication with the data store 114 may be achieved over the Internet 104 using any suitable electronic communication medium, communication protocol, and computer software including, without limitation: a wired connection, WiFi or other wireless network, cellular network, or satellite network; TCP/IP or another open or encrypted protocol; browser software, application programming interfaces, middleware, or dedicated software programs. Electronic communication with the data store 114 may be achieved over another type of network, such as an intranet or virtual private network, or may be via direct wired communication interfaces or any other suitable interface for transmitting data electronically from a data store 114 to the server 100. A data store 114 may include a repository of information that is or can be made freely or securely accessible by the server 100.

In one embodiment, the data store 114 is configured to store information pertaining to a particular user account or a plurality of user accounts for an online domain name management service. Such information may include, for example, demographic information (e.g., name, contact information), payment information, account preferences and settings, and one or more records of a plurality or domain names which are currently owned by and/or managed by a user of the user account or, in some embodiments, are included as part of a wish list or watch list. Additionally, the data store 114 may include information required to provide a user interface to allow a user 112 or a client device 106 to interact with the domain name management service. Such information may include information to provide a website or web page allowing a user 112 of a user account to interact therewith to manage a plurality of domain names. Other suitable information stored within the data store 114 may include, without limitation: databases or database systems, which may be a local database, online database, desktop database, server-side database, relational database, hierarchical database, network database, object database, object-relational database, associative database, concept-oriented database, entity-attribute-value database, multi-dimensional database, semi-structured database, star schema database, XML database, file, collection of files, spreadsheet, or other means of data storage located on a computer, client, server, or any other storage device known in the art or developed in the future; file systems; and electronic files such as web pages, spreadsheets, and documents. Such data stores 114 may also include, without limitation to the illustrated examples: search engine databases; website information databases, such as domain registries; hosting service provider databases; website customer databases, and internet aggregation databases such as archive.org; government records databases, such as business entity registries maintained by a Secretary of State or corporation commission; public data aggregators, such as FACTUAL, ZABASEARCH, genealogical databases, and the like; social networking data stores, such as public, semi-private, or private information from FACEBOOK, TWITTER, FOURSQUARE, LINKEDIN, and the like; business listing data stores, such as YELP!, Yellow Pages, GOOGLE PLACES, LOCU, and the like; media-specific data stores, such as art museum databases, library databases, and the like; point-of-sale transaction data stores; and offline crawling data stores.

In certain embodiments, the web server 100 is also communicatively coupled a Domain Name System (DNS) server 116 through the Internet 104 or locally through a LAN.

The Internet 104 comprises a vast number of computers (e.g., client devices 106) and computer networks that are interconnected through communication links. The interconnected computers exchange information using various services. In particular, a request for a web page or website may be made to the server 100 or another server by visiting the website's address, known as a Uniform Resource Locator (“URL”). Upon receipt, the requesting device can display the web pages. The request and display of the websites are typically conducted using a browser being an application program that effects the requesting and displaying of web pages.

Browsers are able to locate specific websites because each website, resource, and computer on the Internet has a unique Internet Protocol (IP) address. Presently, there are two standards for IP addresses. The older IP address standard, often called IP Version 4 (IPv4), is a 32-bit binary number, which is typically shown in dotted decimal notation, where four 8-bit bytes are separated by a dot from each other (e.g., 64.202.167.32). The notation is used to improve human readability. The newer IP address standard, often called IP Version 6 (IPv6) or Next Generation Internet Protocol (IPng), is a 128-bit binary number. The standard human readable notation for IPv6 addresses presents the address as eight 16-bit hexadecimal words, each separated by a colon (e.g., 2EDC:BA98:0332:0000:CF8A:000C:2154:7313).

IP addresses, however, even in human readable notation, are difficult for people to remember and use. A URL is much easier to remember and may be used to point to any computer, directory, or file on the Internet. A browser is able to access a website on the Internet 104 through the use of a URL. The URL may include a Hypertext Transfer Protocol (HTTP) request combined with the website's Internet address, also known as the website's domain name. An example of a URL with a HTTP request and domain name is: http://www.example.com. In this hypothetical URL, as used throughout, the “http” identifies the URL as a HTTP request and the “example.com” is the domain name. A domain can host multiple websites that can be accessed by appending character strings that constitute the full path to the website's files. For example, the domain for FACEBOOK includes one or more websites, as the term is used herein, for each of its users. A user-specific website is requested by appending a directory to the FACEBOOK main URL, e.g.: http://www.facebook.com/username.

Domain names are much easier to remember and use than their corresponding IP addresses. The Internet Corporation for Assigned Names and Numbers (ICANN) approves some Generic Top-Level Domains (gTLD) and delegates the responsibility to a particular organization (a “registry”) for maintaining an authoritative source for the registered domain names within a TLD and their corresponding IP addresses. For certain TLDs (e.g., .biz, .info, .name, and .org) the registry is also the authoritative source for contact information related to the domain name and is referred to as a “thick” registry. For other TLDs (e.g., .com and .net) only the domain name, registrar identification, and name server information is stored within the registry, and a registrar (e.g., GODADDY) is the authoritative source for the contact information related to the domain name. Such registries are referred to as “thin” registries. Most gTLDs are organized through a central domain name Shared Registration System (SRS) based on their TLD.

The process for registering a domain name with .com, .net, .org, and some other TLDs allows a user 112 to use an ICANN-accredited registrar, such as GODADDY, to register their domain name. For example, if the user 112 wishes to register the domain name “example.com,” the user 112 may initially determine whether the desired domain name is available by contacting the domain name registrar. The user 112 may make this contact using the registrar's web page and typing the desired domain name into a field on the registrar's web page created for this purpose. Upon receiving the request from the user 112, the registrar may ascertain whether “example.com” has already been registered by checking the SRS database associated with the TLD of the domain name (e.g., “.com”). The results of the search then may be displayed on the web page to thereby notify the user 112 of the availability of the domain name. If the domain name is available, the user 112 may proceed with the registration process. Otherwise, the user 112 may keep selecting alternative domain names until an available domain name is found. Domain names are typically registered for a period of one to ten years with first rights to continually re-register the domain name.

A user 112 (e.g., individual or entity) may amass a portfolio of domain names that they own or are otherwise responsible for. This portfolio may be associated with, for example, a user account for a domain name management service offered by the server 100. The domain name management service may be provided by a domain name registrar (e.g., GODADDY) as a free or paid service. A user 112 may be required to log on to the particular user account upon accessing the domain name management web service through the Internet 104. In certain embodiments, some or all domain names in the portfolio may be owned by, licensed by, or managed by the user 112 of the user account. The plurality of domain names within the portfolio may have been procured by the user (e.g., through a purchase or transfer) through the domain name management service, or through another available service. The plurality of domain names may be managed by the domain name management service (e.g., by performing status updates and data updates for the domain names). Other domain name management features not explicitly disclosed herein but understood in the art are contemplated by this disclosure, as well. Some or all of the plurality of domain names in the portfolio may be purchased or managed at other online domain services, but are associated nonetheless with the user 112 of the user account through ownership or other property interest (e.g., contract, license, etc.). This ownership or interest may be determined through investigation by the server 100 performing domain lookup procedures (e.g., a WHOIS query), the server 100 contacting the other online domain name service, or by a user 112 indicating ownership or property interest in the domain name. In certain embodiments, the portfolio of domain names may include one or more domain names that the user 112 does not presently have an ownership or property interest in, but that the user 112 may be watching or is otherwise interested in procuring. Further, the embodiments described herein are not exclusively limited to pure domain names (e.g., example.com), but may in certain embodiments included subdomains (e.g., blog.example.com) and directories (example.com/blog).

As the number of domain names associated with the user account grows, the task of managing the plurality of domain names can become increasingly cumbersome. For example, some user accounts may include thousands of domain names associated with the user account. In a commercial or retail setting, a user 112 (e.g., a company) may own or have property interest in thousands of domain names that are related to the name of their company and/or products or services. In an example used throughout this disclosure, a company having the name “Example” may wish to protect their brand (“Example”) and prevent brand domain name confusion. In doing so, the company may procure “example.com” as well as every domain name including “example” in every top-level domain (e.g., example.net, example.biz, example.info, etc.). In another example, the user company may wish to procure multiple domain names covering common or uncommon variations of the brand or product name, possibly in every TLD permutation available (e.g., exampleco.com, exampleco.net, examples.info, exampleinc.ca, example-inc.com, examplecompany.co.uk, etc.). Additionally, the company may wish to procure multiple domain names covering common or uncommon misspellings of the brand or product name, possibly in every TLD permutation available (e.g., exammple.com, exammple.net, exemple.com, exemple.info, exmpl.biz, etc.). If the user company “Example” makes a product called “The Widget”, the user company may wish to procure domain names related to the product, possibly in every TLD permutation available (e.g., widget.com, widget.info, example-widget.net, widgetbyexample.ca etc.). There are many different variations of domain names and domain name procurement strategies that a user 112 may pursue in brand name and product name protection. What is readily apparent is that the number of domain names associated with a user 112 or a user account can quickly become astronomical and unwieldy, particularly when multiple TLD permutations are pursued.

Additionally, and in a different approach, the user 112 may be a domain speculator, domain broker, or domainer, whose primary interest is in buying and selling domain names. For example, a domain speculator user may procure hundreds or thousands of domain names related to the company “Example” discussed above, which they may in turn package together and attempt to sell or license to the company or other domain brokers. However, the domain speculator user may also procure hundreds or thousands of domain names related to an entirely separate entity. What is readily apparent is that the number of domain names within a domain speculator user account may also quickly become astronomical and unwieldy.

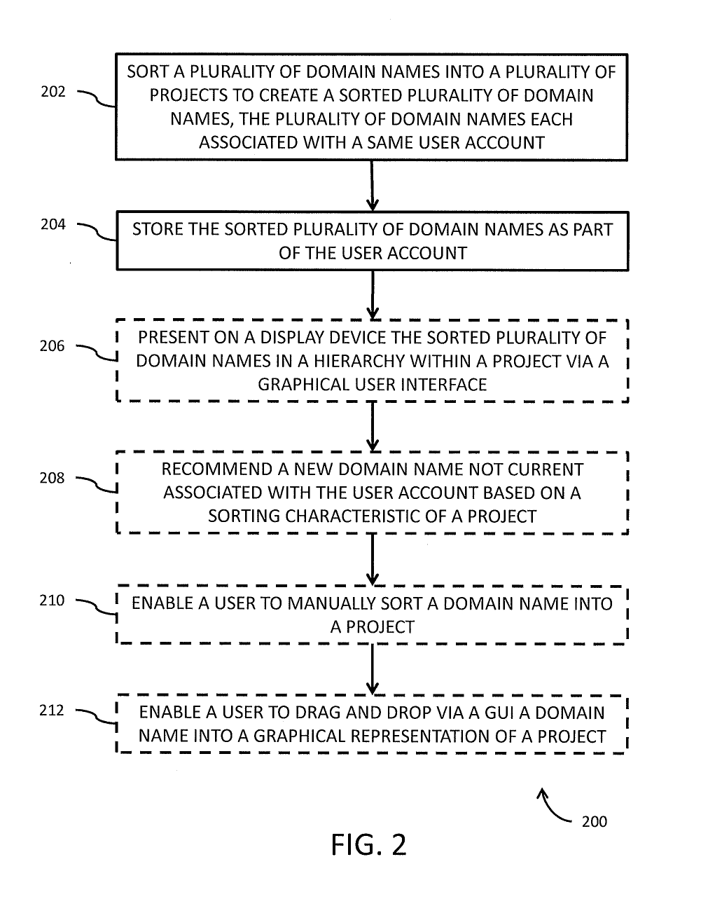

Turning now to FIG. 2, an example flow diagram of a method 200 is illustrated in accordance with various embodiments. In certain embodiments, the method 200 aids in the organization of a plurality of domain names within or associated with a user account. Further, a computing device, such as the server 100 or the client device 106, may be configured to execute all or parts of the method 200 and other methods described herein. The method 200 includes at step 202, sorting by a computing device a plurality of domain names into a plurality of projects to create a sorted plurality of domain names.

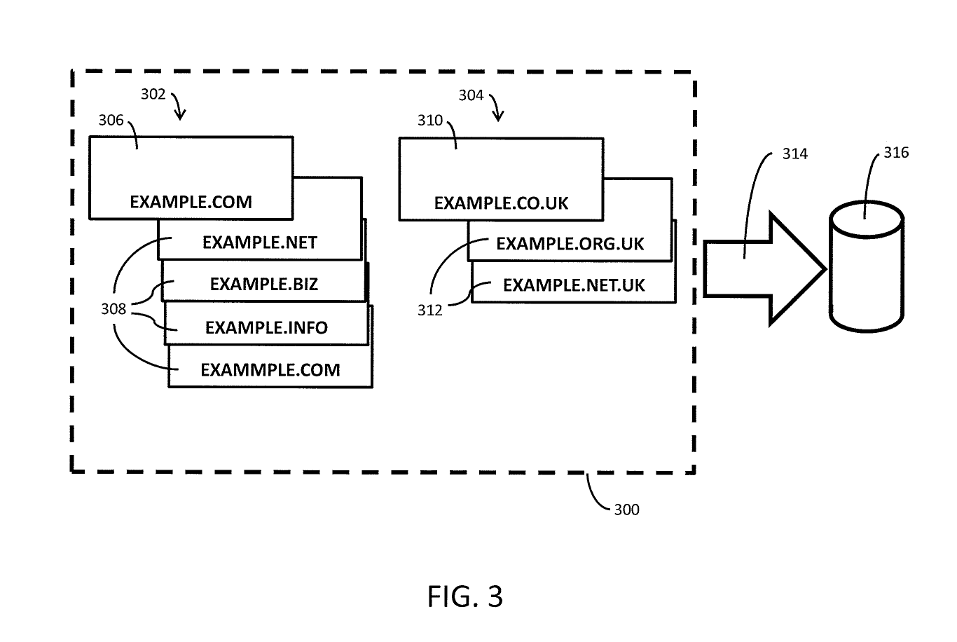

Sorting of the plurality of domain names into a plurality of projects is illustrated in FIG. 3, which is a visual depiction of the method in accordance with various embodiments. Moreover, in at least one approach, the depiction of FIG. 3 may represent one example of at least a portion of a graphic user interface (GUI) configured to enable a user 112 to view, edit, or otherwise modify a sorted plurality of domain names. An example of a sorted plurality of domain names 300 is shown. The plurality of domain names 300 have been sorted per step 202 of FIG. 2 into at least two projects, a first project 302 and a second project 304. In at least one embodiment, the sorted plurality of domain names 300 are associated with the user account. The groupings are called “projects” as they may pertain to one or more domain-name-related projects, tasks, or goals. For instance, as is shown in the example of FIG. 3, the first project 302 may pertain to a project or goal of obtaining as many domain names as possible similar to “example.com” in all TLDs. Therefore, the first project 302 may have a sorting characteristic aimed at that goal. Similarly, the example second project 304 may pertain to a project or goal of obtaining as many related domain names as possible within the United Kingdom (with the TLD “.uk”). Therefore, the second project 304 may have a sorting characteristic aimed at that goal. As is readily understood, these are but two example projects with two example sorting characteristics, and one of skill in the art will understand that many other sorting characteristics (including, for example, schemes, categories, attributes, or other aspects of domain names) may be ascribed to various projects. The teachings disclosed herein are applicable to nearly any sorting characteristic as may be deemed helpful in managing a domain name portfolio, some of which are discussed below. Similarly, the term “project” does not necessarily mean the projects are task oriented. For example, the projects 302, 304 may be based on characterizations or attributes of domain names within the project rather than attributable to a particular goal. Further, the teachings described herein may apply to other domain names, subdomains, directories, etc., not presently owned by the user, but which may be in a “wish list” or “watch list” for the user account, are on backorder by the user, and/or are presently being actively pursued by the user (pre-registrations, auctions in progress, pending and previous offers, etc.), and by other associations.

In this example, as discussed above, the first project 302 includes a sorting characteristic for domain names that are similar to a primary domain name 306 of “example.com”. The primary domain name 306 is shown at the top of the first project 302, and the first project 302 may bear the same title, though other titles may be used (e.g., determined by the server 100 or entered by the user 112). Other secondary domain names 308 are shown below the primary domain name 306. In this example, the secondary domain names 308 are domain names that resemble the primary domain name 306 (e.g., have a different TLD or are misspellings or are similar to the primary domain name 306). Similarly, the second project 304 in this example includes a sorting characteristic for domain names that are similar to a primary domain name 310 of “example.co.uk” and are within the “.uk” TLD. In this example, according to one embodiment, the secondary domain names 308, 312 may be configured to redirect to the respective primary domain name 306, 310.

The primary domain names 306 and 310 may or may not be part of the plurality of domain names 300 that are associated with the user account. For example, if the user account is for a domain speculator or broker, the broker may not own the primary domain names “example.com” or “example.co.uk” but may have created and/or named these projects 302, 304 to sort a plurality of secondary domain names 308, 312 that are associated with the broker's user account (e.g., domain names that the broker owns) that correspond to those primary domain names 306, 308. In such an instance, the actual primary domain name 306, 310 may not have been sorted itself (as it is not purely associated with the user account), but has been determined by the server 100 or the user 112 to be one proper basis for sorting. Further, in some embodiments, some of the plurality of domain names 300 may not be owned by the broker, but may be in a “wish list” or “watch list” for the broker's user account, are on backorder by the broker, are presently being actively pursued by the broker (pre-registrations, auctions in progress, pending and previous offers, etc.), and are associated with the user account in this manner. They may be presented to the user in the GUI in a different manner (e.g., grayed out, different color, etc.). By this, the broker may amass and organize a collection of secondary domain names 308 or 312 that they may later sell or license to the owner of the primary domain name 306, 310 or to some other entity. Many other sorting characteristics are possible for the projects 302 and 304 in this scenario, some of which are discussed below, and the teachings disclosed herein are applicable to nearly all variations of sorting characteristics.

Returning to FIG. 2, the method 200 includes at step 204, storing the sorted plurality of domain names 300 as part of the user account. In FIG. 3, plurality of domain names 300 are stored 314 into a data store 316 to be saved and recalled later. As is understood in the art, many different methods of formatting the data to store 314 the sorted plurality of domain names 300 are possible and are contemplated by this disclosure. The data store 316 may be the data store 114 in FIG. 1, or another data store (e.g., a data store in the second server 108, or another remote or local server).

At step 206, in one embodiment, the method 200 includes presenting on a display device 110 the sorted plurality of domain names 300 in a hierarchy within at least one of the plurality of projects (e.g., projects 302, 304) via a graphical user interface (GUI). The actual format, appearance, and/or function of the GUI may be very diverse from one application setting to another. One example of this is shown in FIG. 3 with a primary domain name 306, 310 on top and secondary domain names 308, 312 shown graphically under the respective primary domain name 306, 310 in a hierarchal manner. The user 112 may be able to hide or show the secondary domain names 308, 312. By this, a user 112 can quickly see the hierarchy of the project to determine the project's purpose, sorting characteristic, progress, volume, value, diversity, or another metric.

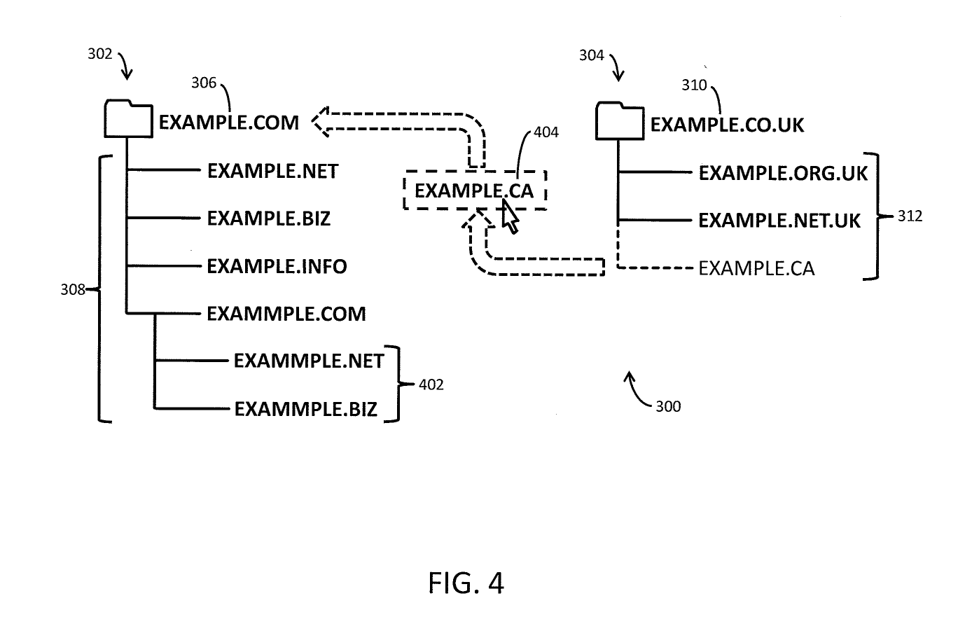

Turning now to FIG. 4, another representative portion of an example GUI is shown in accordance with another embodiment. Here, the first project 302 and second project 304 are shown within a familiar folder structure. The primary domain names 306, 310 are shown as the top or root folders, while the secondary domain names 308, 312 are shown as the sub-folders or sub-files within the root folder. The secondary domain names 308, 312 can be shown or hidden by expanding the top or root folder. In certain embodiments, the secondary domain names 308, 312 may include various nested levels of secondary domain names. For example, the first project 302 may include additional secondary domain names 402 as part of the sorted secondary domain names 308. These additional secondary domain names 402 may be further sorted under a higher secondary domain name. Here, the misspelled domain name “exammple.com” is a secondary domain name to the properly spelled primary domain name “example.com”, while additional secondary domain names 402 of “exammple.net” and “exammple.biz” are similar to the misspelled domain name “exammple.com” and may be sorted thereunder as secondary domain names thereto. Other misspellings may include omissions of period delineators (e.g., “wwwexample.com” or “examplecom.com”) or plural or singular versions (e.g., “examples.com”). Again, many possible different GUIs and GUI formats are possible to display on a display device 110 of a client device 106 beyond those illustrated in FIGS. 3 and 4 to depict the sorted plurality of domain names 300 in a hierarchical manner. For example, domain names could be graphically presented as screenshots corresponding to content at the address of the domain name or of other images associated with the particular domain name instead of or in addition to the domain name.

Continuing with FIG. 2, in one embodiment, the method 200 may at step 208 include the server 100 of the domain name management service recommending at least one new domain name not currently associated with the user account based at least in part on a sorting characteristic of one or more projects. Continuing with the previous examples, a domain name of “eexample.com” or “example.org” may be recommended to the user 112 for inclusion in the first project 302 as they are misspellings of the primary domain name 306 “example.com”. The user 112 may then purchase the suggested domain names if they are available or add the suggested domain names to one or more projects under a wish or watch list. Recommended domain names may be based on any sorting characteristic or based on any project.

At step 210, in one embodiment the method 200 includes enabling a user 112 of the user account to perform at least one manual sorting action of a domain name into a project. As is shown at step 212, in one approach, the manual sorting may include enabling a user 112 of the user account to drag and drop via a GUI the at least one domain name into a graphical representation of one of the projects. In another embodiment still, the method 200 may include the user 112 performing these steps 210, 212. FIG. 4 shows a domain name 404 of “example.ca” being manually sorted by the user 112 manually dragging and dropping the domain name 404 from the second project 304 into the first project 302. Many other methods of graphical domain name manipulation and sorting are possible. For example, on a touch-screen enabled device, a user 112 can touch, pinch, spread, swipe, throw, fling, flick, scroll, drag, multi-finger gestures (e.g., rotate, zoom, scroll, etc.), or perform another gesture on a graphical representation of a domain name. In another embodiment, the domain name 404 may not have been previously sorted into a project and may be a newly purchase domain name or a domain name newly added to a wish or watch list that is subsequently sorted by the user 112. In certain embodiments, the processing device 102 or another processing device or server may consider manual sorting actions by the user 112 or all users to learn preferences and/or update potential sorting characteristics or sorting algorithms. For example, it may be determined that the TLD “.me” is used more for personal use rather than to geographically represent the country of Montenegro, or that “.buzz” is being predominantly used in a cannabis-related setting rather than a news setting.

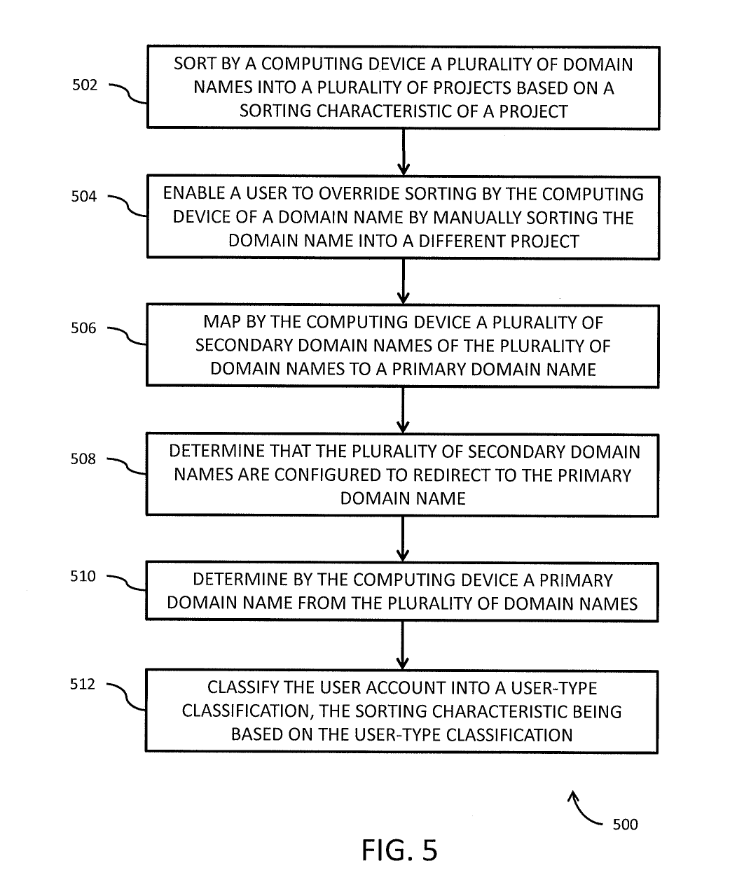

FIG. 5 illustrates alternative or additional method steps 500 that may be performed in addition to or in place of various steps of the method 200 in accordance with various embodiments. A computing device such as the server 100 or the client device 106 may be configured to execute one or more of the steps illustrated in FIG. 5 or described in other methods elsewhere herein. In one embodiment, as show at step 502, a computing device, such as the server 100, may perform the sorting of the plurality of domain names into the plurality of projects to create the sorted plurality of domain names 300 based on a sorting characteristic of one or more of the projects. The sorting by the computing device may occur automatically without or independent of any action of the user 112 or with minimal input on the part of the user 112 (e.g., the user 112 issuing a command to begin sorting the plurality of domain names, or the user 112 designating a sorting characteristic or a primary domain name for one of the projects).

In some embodiments, an unsorted plurality of domain names may become a sorted plurality of domain names 300 completely by the computing device. In another embodiment, a plurality of domain names sorted in one manner may become the sorted plurality of domain names 300 sorted in another manner completely by the computing device. This may include the computing device (e.g., server 100) selecting or determining one or more sorting characteristics of one or more of the projects, selecting a primary domain name, and/or sorting the plurality of domain names according to the sorting characteristics.

In certain embodiments, at step 504, the computing device (e.g., server 100) may enable a user 112 of the user account to override a sorting of at least one domain name by the computing device by enabling the user to manually sort the domain name into a different project. This is illustrated in FIG. 4 where the domain name 404 “example.ca” is being manually sorted from the second project 304, which the computing device originally sorted it into, to the first project 302. Many other methods of executing such a manual override are possible (e.g., typing in the project into which to place the domain name, clicking a check box, etc.), all of which are contemplated by this disclosure.

One method of sorting the plurality of domain names by the computing device (e.g., server 100) may include, as is included at step 506, the computing device mapping a plurality of secondary domain names (e.g., 308 and 312) to at least one primary domain name (e.g., 306 and 310). Mapping may include the computing device determining one or more “connections” between the secondary domain name and the primary domain name. These connections may be logical connections (e.g., the secondary domain name is configured to redirect to the primary domain name, all the domain names have the same TLD, etc.) or other subjective connections (misspellings and the like).

In certain embodiments, as is shown at step 508, mapping further entails the computing device determining that all or some the plurality of secondary domain names are configured to redirect to the primary domain name. This can be determined through a series of WHOIS lookups or through reviewing other locally stored data pertaining to the plurality of domain names, these lookups or data informing the computing device of the redirect configurations.

In other embodiments, as is shown at step 510, the computing device may determine the primary domain names from the plurality of domain names. In the previous examples used herein and illustrated in FIGS. 3 and 4, if the misspelled secondary domain name “exammple.com” redirects to the correctly spelled primary domain name “example.com,” then the computing device may determine that “example.com” is the primary domain name and the redirected domain name is a secondary domain name thereto. In other approaches, a primary domain name may not be associated directly with the user account, but may still be selected as such. For example, if the user account manages a portfolio of misspellings of “example.com”, but the domain “example.com” itself is managed by a different user account or by a different entity entirely.

The above described methods are but a few methods of determining mappings and primary domain names and of sorting a plurality of domain names. Many other sorting characteristics may be determined and various other connections between domain names may be determined based on a plethora of data. That data may be related directly to the domain names themselves, to the user 112 or the user account, or may be based on other data indirectly related to the domain names. In various embodiments, the computing device (e.g., server 100) may perform or effect performance of data analytics or logical clustering analysis (e.g., “big data” analysis) on a plurality of domain names to sort domain names into projects, to determine a primary domain name (if applicable), to determine sorting characteristics of projects. These processes may search for patterns or similarities within groups of domain names in the plurality of domain names to create the projects.

Various data sets and data types may be used in determining projects, groupings, sorting characteristics of the projects, and in the sorting process itself. In one approach, email addresses attached to a domain name may be utilized. In a non-limiting example, if a plurality of domain names all have the same email address or email address domain, they may be grouped into a project. Further, the domain of the email address may indicate the primary domain name for the project. In another approach, the computing device may utilize information as to whether a hosting site is attached to a domain name, whether content is located at the address of the domain name, or whether an online store is attached to the domain name. In a non-limiting example, if a domain name does not include an associated hosting site or an address of a hosting service, does not link to actual web content, or does not include an online store, the computing device may infer that the domain name is not a primary domain and is therefore a secondary domain, whereas the presence of these aspects may infer the opposite. Additionally, the computing device may examine the amount of income or money generated by an online store to determine which domain names are primary domain names.

In another approach, the computing device may utilize a number of hits (e.g., direct URL entries and search engine hits) generated by various domain names to sort the domain names. In a non-limiting example, if one domain name generates thousands or millions more hits than another, it may be inferred that the high-traffic domain name is the primary domain name while the other is a secondary domain name. In other embodiments, high volumes of email traffic associated with a domain name may be similarly indicative. In other embodiments still, a user, DNS information, and/or other external sources may provide information that is similarly indicative.

In another embodiment, data relating to geographical or language-based aspects of domain names and domain name searches or DNS requests may be used by the computing device during sorting. In a non-limiting example, a plurality of domain names may be sorted geographically to service various parts of the world. For example, one version of a website “example.com” may be primarily for the United States, while another version of the website may be for Mexico (e.g., “example.mx” or “mexico.example.com”) or India (e.g., “example.in” or “india.example.com”). In another example, a version of the website may be for French or Spanish speaking users (e.g., “francais.example.com” or “espanol.example.com”). Domain names may be sorted according to these aspects. Additionally, other geographical or language-based information may be utilized in sorting domain names, including but not limited to originating locations of Domain Name System (DNS) requests for the domain name, incoming language of domain name requests, languages used by requesting client devices for the domain name, location of request client devices for the domain name, and so forth. Still other geographical information may include, for example, utilization by a user 112 of a user account of a maps program or application including geographic aspects or geographical search history that may provide information regarding a geographical or lingual nature of a domain name or project, or other aspects in general pertaining to the domain name or project.

In another embodiment, data relating to search engine handling of the domain name or terms within a domain name string may be utilized by the processing device during sorting of the domain names as sorting characteristics. Some examples include the number of search engine queries for a domain name, search engine autocomplete suggestions associated with the domain name, search engine search request correction suggestions associated with the domain name, information from a Search Engine Optimization (SEO) pertaining to a domain name or a project, and/or information from a Search Engine Marketing (SEM) scheme pertaining to domain name or a project (e.g., via GOOGLE ADWORDS, BING ADS, and BAIDU). For example, if a particular domain name string is used in many search engine queries or a particular website having that domain name is often selected in response to a particular search engine query, then it may be inferred that the particular domain name is a primary domain name or is the focus of a particular project. In another example, information as to whether or how often a search engine autocompletes a search request entry to a particular domain name string may be used. Similarly, information as to whether or how often a search engine will suggest a corrected domain name string in response to a misspelled search engine query may be used. Similarly still, how often users of the search engine select the autocompleted or corrected versions of domain name strings may indicate a primary domain, a project, or that secondary domain names (e.g., the misspelled versions) can be associated with the subsequently selected primary domain names. In a similar fashion, autocorrect functions, algorithms, and results may be useful in determining a primary domain name and/or secondary domain names (e.g., in determining which is a common misspelling of the other).

In another non-limiting example, SEO data or SEM data attached to or pertaining to a domain name or a project may be useful in sorting the domain names. For example, the attachment of SEO or SEM data to a domain name may be indicative that the domain name is a primary domain name or that other secondary domain names referenced by or targeted by the SEO or SEM may be secondary to the primary domain name. This SEO and SEM data may be utilized to sort domain names in a multitude of other methods not explicitly described herein, but which are contemplated by the present disclosure.

Is still another embodiment, data relating to the user account or a user 112 of the user account may be utilized by the computing device to sort the plurality of domain names. For example, a domain name search history record associated with the user account or a domain name aftermarket auction history associated with the user account may be helpful in determining what domain names the user 112 is interested in procuring or investigating. This information may provide additional insight as to which domain name may be a primary domain name or the focus of a project, which domain names are secondary domain names, and a proper sorting of the plurality of domain names. For example, the fact that a user 112 often searches for domain names that are similar in spelling to a particular domain name may indicate that the particular domain name is the pertinent primary domain name.

Additionally, user account interaction history may be used by the processing device to sort the plurality of domain names. A history of user 112 interactions with the user account may include the frequency which the user 112 logs on, performs searches, or purchases, sells, or edits domain names. Other user account interaction information may include email traffic associated with the user account (e.g., domain names of email addresses for messages sent to or from an email account associated with the user account). Further, email content associated with the user account or content of email messages associated with the user account can be utilized in sorting the plurality of domain names.

Other examples of user account interaction information may include user utilization of or investigation into other features that may be offered as part of the user account. For example, if a user 112 utilizes or investigates a website builder tool in association with a particular domain name, activates or investigates data hosting associated with a particular domain name, or purchases or sets up an email address associated with a particular domain name, it may be indicative that the domain name is a primary domain name.

Further still, user account interaction information may include interaction information not directly pertinent to the plurality of domain names. For example, user interaction with other features or offerings of the user account or other linked applications or web services not directly related to the domain name portfolio (e.g., in general: web search, email, maps, documents, photos, cloud storage, music, calendars, online meetings, collaborations, and so forth). These interactions provide a wealth of information that can be used in various ways to help sort the plurality of domain names, determine projects, and determine primary and/or secondary domain names, all of which are contemplated by this disclosure. Moreover, other locally stored data (e.g., data stored on the client device 106 such as cookies, favorites, browser history, and the like) may be similarly used.

In general, the various data used to sort the plurality of domain names may be processed by the processing device (e.g., server 100) or processed by a different server 108 to perform data analytics and/or clustering analysis as is understood in the art. The results of the data analytics or clustering analysis may yield any number of differing resultant sorted plurality of domain names 300 having different domain name classifications or groupings. For example, if multiple different sorting schemes are determined, some or all of the multiple sorting schemes may be provided to a user 112 to select the most appropriate or useful sorting scheme. The domain name management service may have a default sorting scheme which can in turn be modified by the user 112.

In one approach, as is shown at step 512 of FIG. 5, the computing device may classify the user account into a user-type classification. A sorting characteristic of one or more of the projects may then be based upon the user-type classification. Such user-type classifications may include but are not limited to a primary user-type (which may include an individual or entity such as a company that uses one or more of the domain names in a commercial or non-commercial way to output web content at the location corresponding to the domain name) and a domain name broker user-type (which may include a domain speculator or broker whose primary goal in owning a domain name is to subsequently sell it or license it for a profit). Many other user-types may exist and are contemplated by this disclosure. These different user-types may benefit from differing methods of sorting a plurality of domain names. For example, a primary user-type may benefit most by having the domain names sorted into projects based on their similarity to a primary domain (e.g., “example.com”), possibly into different projects based on the number of improper letters in a misspelling of the primary domain name, or sorted geographically based on region or country. However, a broker user-type may benefit most by having the domain names sorted into projects based on their estimated value, number of letters, or other factors. Therefore, the user-type classification can be useful for the processing device to understand when determining how to sort the plurality of domain names and/or how to select sorting characteristics of the projects and/or the projects themselves.

To determine the user-type classification, the computing device may look at the settings of the user account (e.g., to determine if a user-type has been selected or indicated by a user 112 of the user account) or other factors. In certain examples, this classification may be made through the use of data analytics to determine whether the user's actions are in line with a primary user (e.g., most of the domain names in the user account focused on a particular theme or are similar in nature, or the user has actual content attached to one or more of the domain names) or in line with a broker (e.g., most of the domain names are fairly diverse and without substantive content attached to any particular domain name). Similarly, if a user 112 investigates a website builder tool, data hosting options, or other features associated with the user account, it may be indicative that the user account is a primary user. Data analytics, as are understood in the art, may be performed by the server 100 or by a different server such as the second server 108.

By implementing the disclosed domain name sorting methods, users 112 are able to easily keep track of a plurality of domain names grouped by projects. Further, in some embodiments, sorting can occur automatically thereby reducing or eliminating the amount of time a user 112 is required to spend to organize a portfolio of domain names. In some embodiments, the computing device may facilitate a combination of user-initiated and automatic grouping of domain names and their attached data into projects, via any of the user interfaces and any of the communications between processors and data stores described herein.

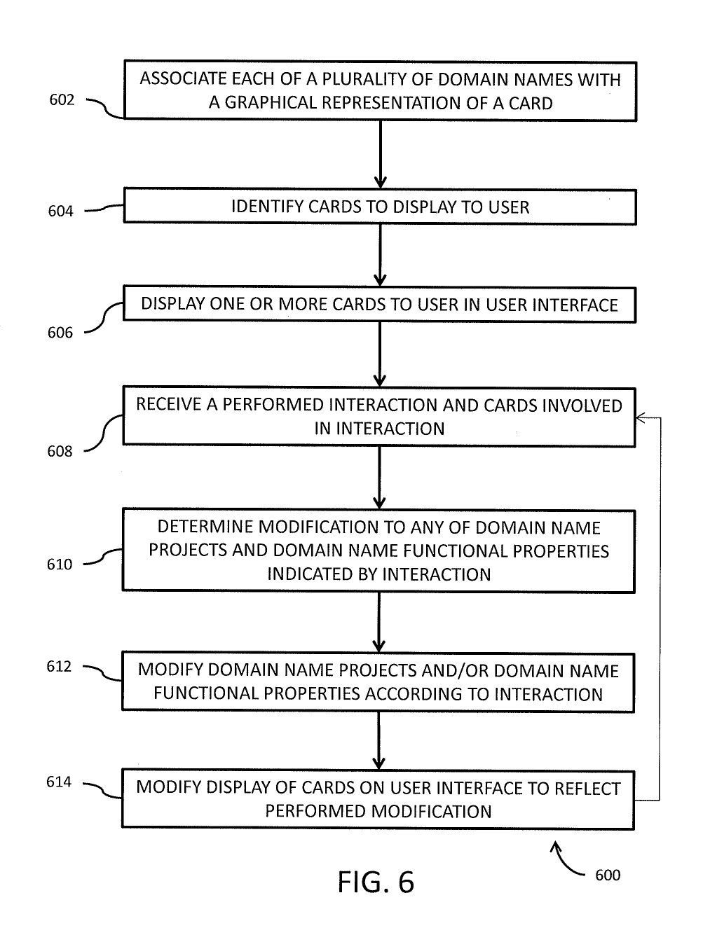

FIGS. 6-9 illustrate another method and exemplary interface for creating the domain name projects of the present disclosure. Similarly to the “tiled” domain name hierarchy display of FIG. 3, any of the sorted (e.g., into a project) and unsorted domain names of the user's account may each be displayed on a “tactile” card. The cards are tactile in the sense that the visual and interactive representations of the virtual card to the user approximate a physical (i.e., real-life) instance of a card with information written on one or both sides, such as a note card, flash card, baseball card, etc. The cards may be “laid out” on a virtual table, referred to herein as a screen layout, and the user may use a touchscreen or other input device to move, flip, fold, tear, stack, sort, shuffle, and perform other interactions with the cards in order to organize and manage the user's portfolio of domain names.

Referring to FIG. 6, a server (e.g., server 100 of FIG. 1) may create the cards and present them in the interface before, during, or after sorting the domain names into projects as described above. At step 602, the server may associate each of the user's domain names with a card to be displayed in the interface. The association may include identifying data related to the domain name for display on each side of the card. Various examples of data for display are described below and include, without limitation, the domain name itself, any functional properties of the domain name, and any project information for the domain name's project, such as the project identifier or theme, or the relationship of the domain name to the primary domain name of the project. Data on each card may further include indicators and prompts, such as buttons or icons, for the user to click to perform actions. Non-limiting examples include one or more recommended domain names each with a prompt for the user to purchase the domain name, one or more alerts such as domain name expiration alerts and renewal links, prompts for performing further configuration of the associated domain name, and prompts to share information about the domain names and/or projects on a social media platform. An exemplary embodiment of a card includes the domain name displayed with prominence on the front of the card, with a list of services (e.g. email, domain forwarding, domain security) applied to the domain name displayed as text or icons on the back of the card. Another exemplary embodiment of a card includes the domain name and iconized indicators of the applied services on the front, and WHOIS information and/or domain traffic statistics displayed on the back.

At step 604, the server may identify which of the cards should be displayed to the user in the user interface. A subset of the cards or all of the cards may be simultaneously displayed on the screen layout. Identifying the cards may include receiving an indication from the user of which subset of cards to display. For example, the user may select via the user interface a project of interest, and the server may identify the card associated with the domain names in the selected project for display. At step 606, the server may display the identified cards to the user on the screen layout within the user interface, as described further below.

At step 608, the server may receive data pertaining to an interaction that the user has performed with the cards on the user interface. Exemplary interactions are described below. The interactions may be integrally associated with certain modifications to the properties of the domain names of the cards involved in the interactions. For example, a lookup table may associate the interactions with the modifications to be made. Thus, at step 608 the server may receive the interaction data indicating, for example, that the user dragged the card for A.com onto the card for B.com; at step 610 the server may determine from the lookup table that the appropriate modification is to forward the domain name of the dragged card to the domain name of the stationary card. At step 612, the server may perform the appropriate modification, such as by creating a 302 redirect HTTP header for A.com pointing to B.com in the example. At step 614, the server may modify the display of the cards on the screen layout to reflect the new properties of the domain names in the interaction, and may wait for the next interaction.

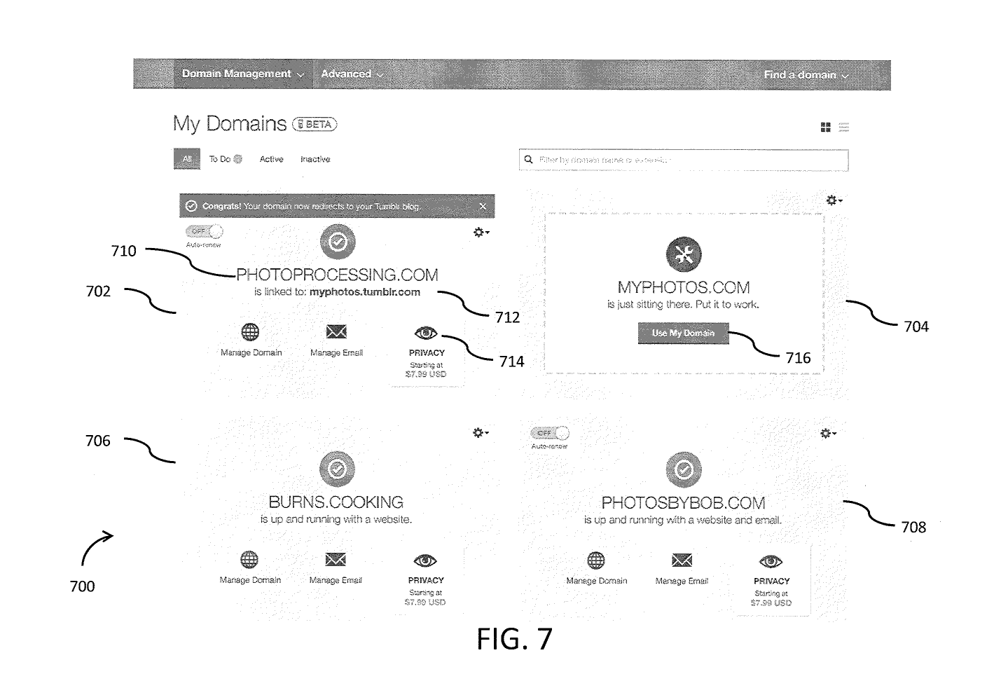

The exemplary interface of FIG. 7 shows a plurality of cards 702, 704, 706, 708 arranged on a screen layout 700 of a user interface. Each card pertains to one of the domain names in the user's account, and displays the domain name 710 on the front of the card. Additional properties of the domain name may be displayed on the front of the card as well, as described above. In the example of FIG. 7, a first card 702 displays a domain summary 712 comprising text that conveys important information about the domain name. The important information may include one of the functional properties of the domain name. For example, the domain summary 712 of the first card 702 indicates that the domain name is forwarded to a third party service (or, alternatively, that the URL at the third party service is forwarded to the domain name). An icon 714 for each web service applied to the domain name may be displayed. Referring to the second card 704, the cards may also convey indicators that more configuration of the domain is needed. For example, the server may determine that there is no web content hosted at the domain name of the card 704, and may format the front of the card 704 so that the domain summary 712 indicates more configuration is needed. In this case, the domain summary 712 may further include one or more buttons 716 prompting the user to configure the domain name.

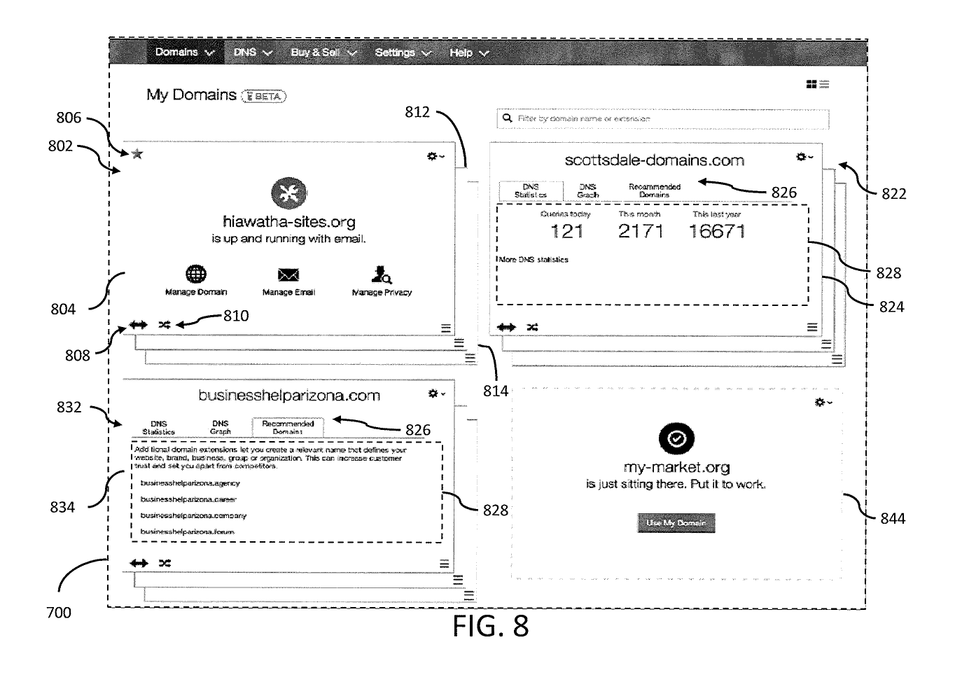

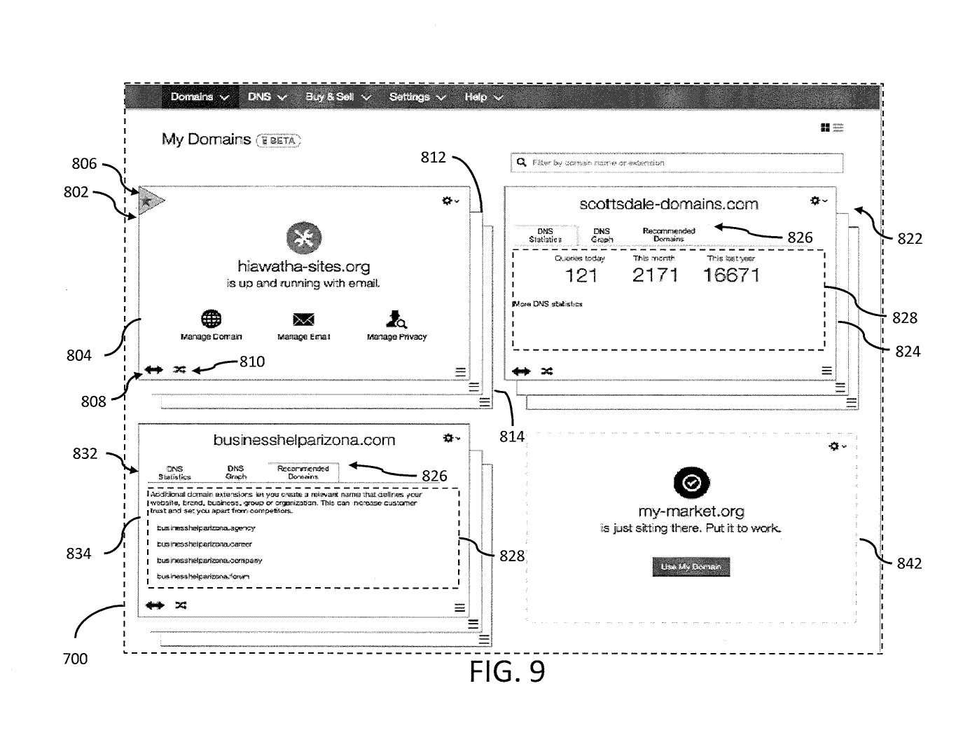

FIG. 8 shows the screen layout 700 of FIG. 7 with a plurality of card stacks 802, 822, 832 presented to the user. A card stack may represent a domain name project as described herein. The top card 804, 824, 834 of each stack 802, 822, 832 may be the “primary card”, which may relate to the primary domain name of the project represented by the stack. Alternatively, the top card 804, 824, 834 may not indicate any primacy of the associated domain name, and may further be selected at random, such as in the shuffling interaction described below. Building on the description of FIG. 7, several “clickable” icons, images, or text links may be presented to the user to perform interactions with the top card, one or more of the other cards in the stack, or the stack in its entirety. For example, the top card 804 of a first stack 802 of the displayed stacks 802, 822, 832 includes a mark icon 806, a flip icon 808, and a shuffle icon 810. The mark icon 806 may mark the top card 804 as a “favorite” of the user, which may cause the interface to, for example, keep the top card 804 at the top of the stack 802 regardless of other interactions (e.g., shuffling) performed on the stack 802. Additionally or alternatively, the mark icon 806 may mark the top card 804 as needed additional configuration (see the “dog-earring” interaction below). The appearance of a marked card may change from its unmarked state, as shown with regard to the top card 804 in FIG. 9.

The flip icon 808 may alter the display of the top card 804 by “flipping” the displayed side of the card 804 from front to back and vice versa. The top card 804 illustrates an exemplary front of the card (also see FIG. 7), while the top cards 824, 834 of the other illustrated stacks 822, 832 in FIG. 8 illustrate exemplary backs of the card. In the exemplary embodiments, the front of a card displays the domain name, any applied or available services, and a summary of the domain name status, and the back of a card displays a navigation menu 826 that the user may select to view different pertinent information in a content pane 828. The exemplary top cards 824, 834 illustrate a navigation menu 826 that allow the user to select between DNS statistics (e.g., number of DNS hits over different time periods, as shown for top card 824), an DNS usage graph, and a list of recommended domain names (as shown for top card 834) based on the domain name of the card, to be displayed in the content pane 828.

The shuffle icon 810 may shuffle the cards of the stack 802 in order to “surface” (i.e., bring to the top) another card (e.g. card 812 or card 814) as described further below. The example screen layout 700 of FIG. 8 further illustrates an ungrouped card 844 that can be dragged into an existing stack 802, 822, 832, used to start a new stack, or simply left on its own.

The cards (e.g., cards 702, 704, 706, 708) may be moved around the screen layout 600 to accomplish organization and managerial tasks. Dragging a card or a stack of cards onto a stationary card may create a new project with the domain name of the stationary card identified as the primary domain name and the domain name(s) of the dragged card(s) identified as secondary, tertiary, etc. domain names. If the stationary card is already in a project, the dragging action may add the dragged card(s) to the project as described above. The card(s) may be added with or without registering the position of the card(s) when the user “drops” them into the project. That is, the dragged card(s) may be added physically below or hierarchically below the card onto which the dragged card(s) were dropped, or the dragged card(s) may be added to the top or bottom of the stack of cards already in the project. Similarly, dragging a card out of stack may remove the domain name from that stacks' hierarchy and, potentially, from the project. The screen layout 700 may include areas (not shown) that indicate the effect on the card (and associated domain name) if the card is dropped there after being dragged from a stack. For example the area may indicate that the card will be removed from the project if it is placed in the area.

Two cards, or a stack and a card, or two stacks, may be “pinched” together, such as by using a pinch gesture on a touchscreen interface. Pinching may join the pinched cards in a common project. The pinched cards may be displayed adjacent to each other, at the same level of a common hierarchy or in separate hierarchies within the same project. Similarly, to sever a connection between two cards (e.g., domain forwarding) or a stack and a card (e.g., placement within a common project), the cards may be “split,” such as by using a two- or three-fingered spread gesture on a touchscreen interface. Additionally or alternatively, the spread gesture may be used on a stack of card to “focus” the screen layout 700 on the stack, such as by spreading the cards out to make data thereon more visible. A spread gesture may be used on a single card to “tear” the card, removing it from the display. Or, a spread gesture may be used on a single card to expand the card on the screen layout 700, allowing more data to be displayed on the card.

Actions may also be performed on multiple cards covering all or part of the screen layout 700, in order to “surface” (i.e., bring to forefront attention) different domain names that haven't been organized by the user. The user may sort the cards manually, such as by drag-and-drop action described above. For example, the user may move a card forward or backward in the stack. Additionally or alternatively, the user interface may include a button or menu item that instructs the server to sort some or all of the cards automatically. The cards may be sorted by any suitable paradigm, such as alphabetically, grouped by TLD, grouped by theme, etc. The user may also shuffle the cards on the screen layout 700 (e.g., by clicking the shuffle icon 810 of FIG. 8). Shuffling may reorder cards in a stack, or may reorder the appearance of stacks on the screen layout 700. In some embodiments, “surfacing” interactions may simply modify the appearance of the cards on the screen layout 700, while the functional properties of the underlying domain names and/or the organization of the projects involved remain unchanged. In such embodiments, the interface may include a button (e.g., marked “apply,” button not shown) or other prompt that allows the user to save the changes caused by the surfacing interaction. If applied, the changes may propagate to the domain names of the modified cards. For example, when a stack is reshuffled and a card that was lower in the stack is brought to the top of the stack, applying the changes may cause the server to change domain forwarding of the domain names on cards lower in the stack to forward to the new top card. In other embodiments, the server may automatically propagate the associated changes to functional properties, etc., upon the user's performing such surfacing interactions.

The physical appearance of each card may be modified by the server or by user interaction, in order to convey information about the corresponding domain name. In one example, a card may be dog-eared by the user, such as by clicking a corner of the card, to indicate that additional configuration must be done before the domain name can be launched. In another example, all or portions of a card may be color-coded to indicate that the domain name needs attention, as well as what type of action is needed and how urgent the attention is. Such visual indications may be cleared manually or automatically when the user has performed the action.

Additionally or alternatively to modifying the project-related characteristics of the cards, any of the user's interactions with the cards may cause a server in the present system, such as server 100 of FIG. 1, to modify one or more functional properties of the domain names of some or all of the cards involved in the interaction. Non-limiting examples of functional properties that may be modified by manipulating the cards include: DNS resource record types, such as A, CNAME, MX, or Sender Policy Framework records; WHOIS database records, including owner, registrar, technical contact, and nameserver records; HTTP header records, such as 301 and 302 redirects; service records, such as auto-renewal and domain name security settings; and application records, such as domain-specific access settings for hosting provider products or links to activated third party services. The server may use any suitable system components and methods for retrieving and modifying the functional properties and applying the changes. Some embodiments of such system components and methods are described in U.S. patent application Ser. No. 14/466,953, entitled “SYSTEM AND METHOD FOR AUTOMATIC CONFIGURATION OF DOMAIN NAMES FOR THIRD PARTY SERVICES,” owned by the present Applicant and incorporated by reference herein.

The server may perform any of the following non-limiting exemplary actions on the functional properties of the domain names in response to the exemplary interactions described above. Dragging a card or a stack of cards onto a stationary card may, for example, cause the server to create an HTTP 302 redirect or similar domain forwarding characteristic from the domain names of the dragged cards to the domain name of the stationary card. The same dragging action may additionally or alternatively propagate one or more of the functional properties of the stationary card into the dragged cards. For example, the server may change the MX records, nameservers, and/or technical contact information of the dragged cards to match the stationary card. In another example, the server may grant, to the domain names of the dragged cards, access permissions for each of the web applications to which the domain name of the stationary card has access. Additionally or alternatively, the server may remove the dragged-card domain names' access to applications that the domain name of the stationary card cannot access. In another example, if the domain name of the stationary card is set to auto-renew, the domain names of the dragged cards may be set to auto-renew. Furthermore, the renewal dates for all of the domain names in the interaction may be made consistent.

Once cards are stacked, in order to maintain consistency the server may prevent the user from changing some or all of the functional properties of domain names that are slotted below the primary domain name. In some embodiments, the user may modify the functional properties of the primary domain name by interacting with the associated card, and changes may be propagated through the stack. In other embodiments, the user may be permitted to manipulate the functional properties of all or a subset of the secondary, etc., domain names in a stack of cards. Some or all of the functional properties of a domain name may be displayed on the front and/or back of its card, as described above. Where changes to the functional properties are permitted, the user interface may permit the user to make such changes by modifying the displayed values directly on the card. Additionally or alternatively, the user may select the card and be taken to an editing interface.

In a “pinch” interaction, the two domain names of the relevant cards are identified as related but maybe not in a primary-secondary relationship. The server may respond to a pinch by modifying some of the functional properties of one of the domains to match those of the other. The server may prompt the user to identify the domain name having the functional properties that will be kept (e.g., by prompting “Do you want the properties of card B copied to card A, or of card A copied to card B?”). Alternatively, the server may automatically identify the domain name to be changed and change it. For example, between the domain names of the two cards in the pinch, the server may copy the functional properties of the domain name that is more active based on one or more traffic metrics. For example, the server may identify that a first of the domain names has a greater number of DNS hits, a better page rank, or more recently edited data than the second domain name. The interface may enable the user to override the server's automatic selection. Where one or two stacks are involved in the pinch, the functional parameters of the secondary, etc., domain names may be changed in conjunction with those of the primary domain as described above.

When a card is dragged out of a stack, the server may remove some of the values of the domain name's functional properties. For example, any 302 redirect or other domain forwarding, email forwarding, and access to any native or third party applications and services may be eliminated. A card may further be dragged off of the screen layout 700, or “swiped,” to remove the card from the screen layout 700. A user may swipe a blank card onto the screen layout 700. In some embodiments, the blank card may include a prompt that enables the user to perform a new domain name search as described herein.

Embodiments of a user interface for domain name searching may, independently of or in conjunction with the user's portfolio of owned domain names, use the card-based graphical representation of domain names and domain name data described above to present search results. That is, each domain name in a SERP can be displayed on a card together with other card elements to provide an intuitive, manipulatable object that conveys information about the domain name and enables actions related to it. A card can be any shape suitable for display on the user's device, conveyance of information on the card, and provision of a “tactile” interactive experience to the user. “Shape” in this context can include a perimeter or outline, which can be square, rectangular, trapezoidal, circular, etc. Shape can also have three-dimensional qualities, such as thickness, rounded edges, and the like. An exemplary, operational user interface is provided, and it will be understood that the described features can be combined with any of the user interfaces described above or in the priority documents of the present application, which are incorporated herein by reference, and with other search result interfaces.

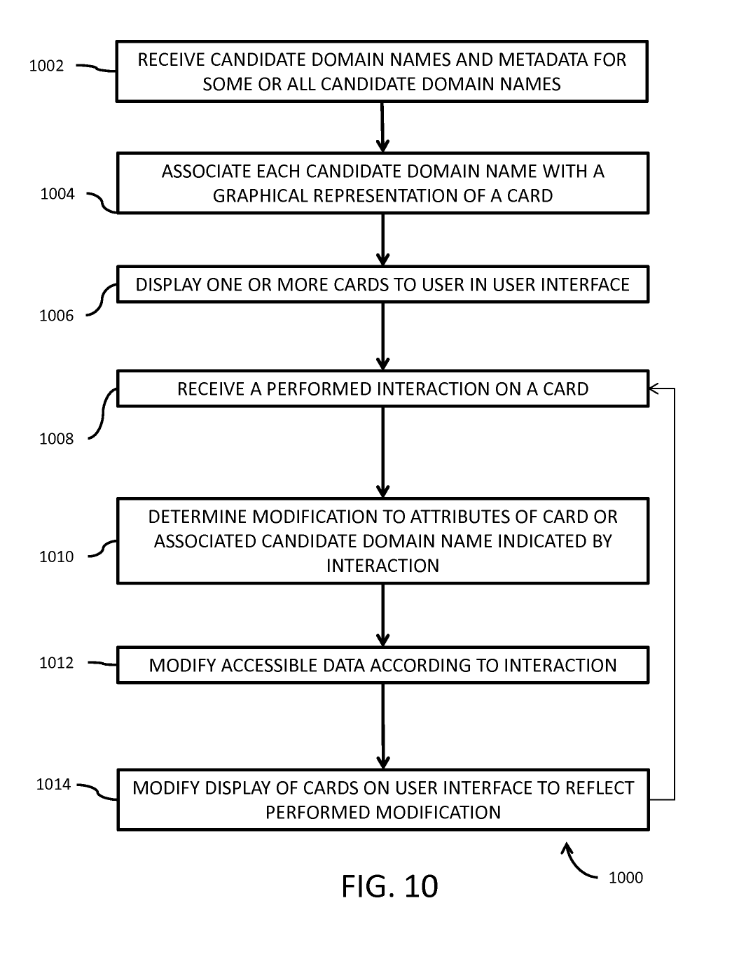

FIG. 10 illustrates a method 1000 for presenting candidate domain name cards in a user interface. At step 1002, the server may receive the candidate domain names, which may be search results of a domain name search. The candidate domain names may be identified or generated by the server (i.e., prior to step 1002 or as a part of step 1002) or by another computer using any suitable domain name search algorithm. In some embodiments, the candidate domain names are generated by “spinning” them from search terms entered into a domain search field, as is known in the art. In some embodiments, the server (i.e., prior to step 1002 or as a part of step 1002) or another computer may confirm that each of the candidate domain names is available for registration. The server may additionally obtain one or more elements of metadata pertaining to one, some, or all of the candidate domain names. The metadata may be relevant to a purchase decision of the user; non-limiting examples of such metadata include a price to be charged for registration, a renewal term, a renewal fee, a class as described herein, one or more connections to other candidate domain names (e.g., projects as described above, sets or bundles as described in the priority documents), one or more connections to an account of the user (e.g., present on a user wishlist or in the user's shopping cart), and the like. The server may receive the metadata from another computer or data store, or the server may generate the metadata. For example, the server may calculate the price using known methods.

At step 1004, the server may associate each of the candidate domain names with a graphical representation of a card as described above with respect to step 604 of FIG. 6. In particular, the card may be configured to display any compilation of the candidate domain name and associated metadata according to the overall layout of the user interface. In some embodiments, the card may hide some of the metadata and require an interaction by the user with the card to reveal the metadata. Some examples of card display are described below and are not limiting.

At step 1006, the server may construct the user interface to include one or more of the cards, and may display the user interface on the user device. At step 1008, the server may receive a performed interaction on one of the displayed cards. Non-limiting example interactions are described below with reference to the Figures. In response to the interaction, at step 1010 the server may determine whether and which modifications to the cards, the candidate domain name, the metadata, or other data are to be made according to the interaction. For example, when a tap or swipe gesture on one of the cards is received, the server operation on the data may depend on the coordinates and direction of the gesture and the state of the user interface (e.g., which card is the “focus card” as described below, or whether the user is logged into his account).

Once the server identifies the modifications to be made, at step 1012 the server modifies the data as directed. The data to be modified may be any data accessible by the server. Thus, there may be modifications to one or more of: the objects (e.g., cards) displayed on the interface; user data such as domain name portfolio (e.g., a new domain is purchased), account balance or transactions, shopping cart, or stored lists (e.g., wishlists, favorites, bookmarks); domain data such as registration status, price, and the like; and other data and systems involved in the data processing of the interaction. The server may additionally store data about the interaction, which data may be used for machine learning purposes, such as to improve the domain name suggestion algorithm or to track trends in domain name purchases. At step 1014, the server may modify the displayed cards according to the processed interaction, such as to update the elements displayed on the interacted card as described below. The server then returns to step 1008 to await the next interaction on the user interface.

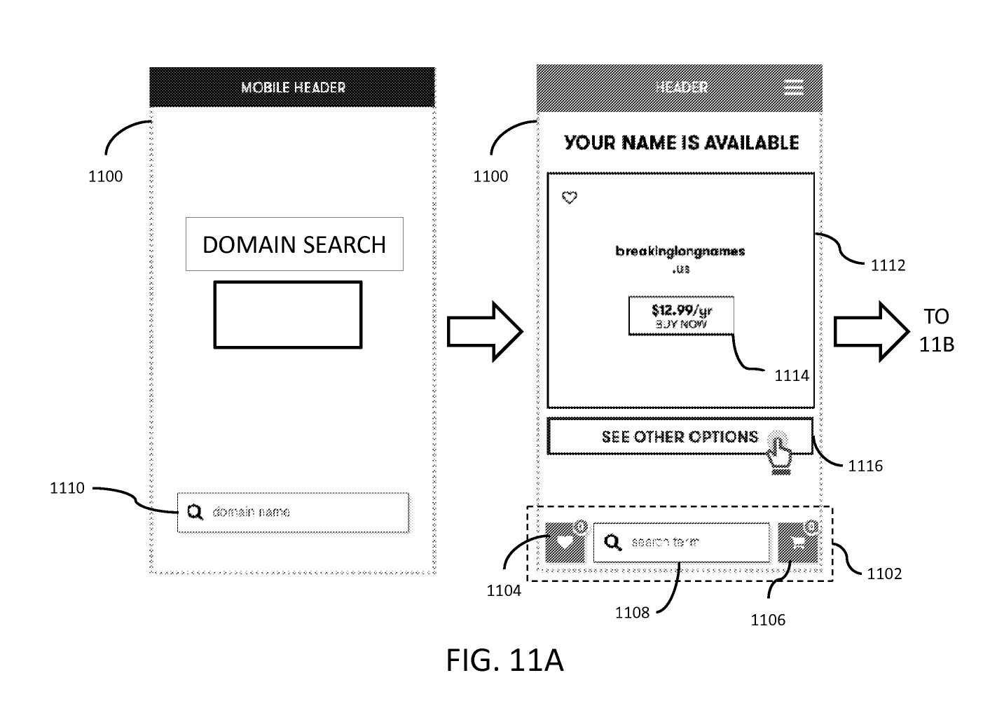

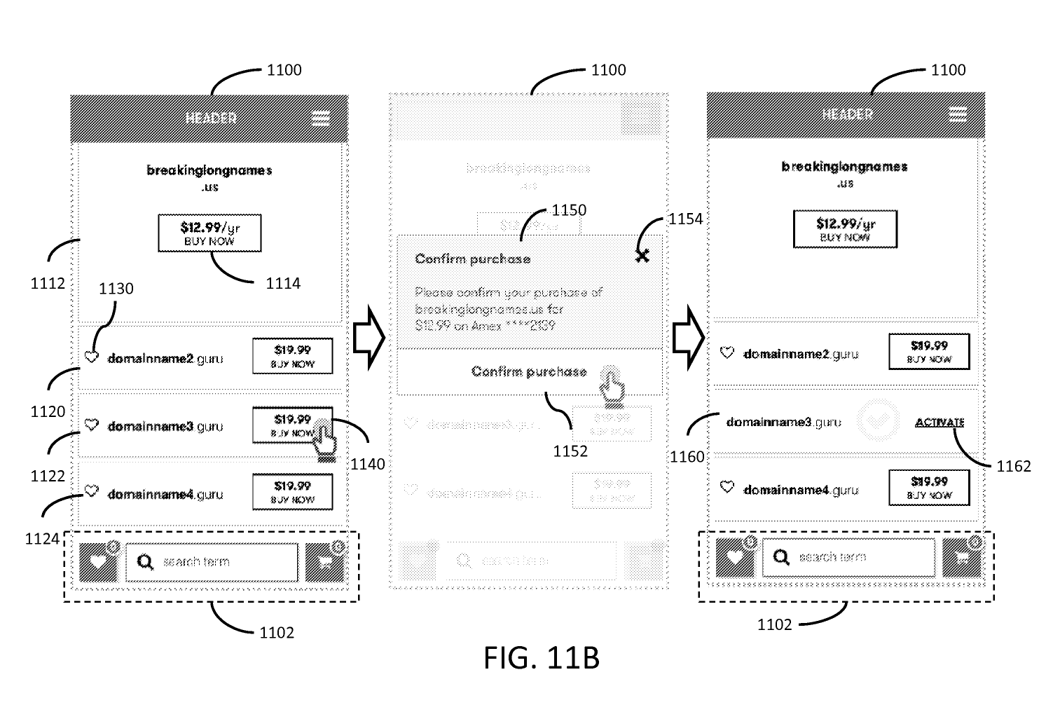

Suitable card-based user interfaces may be adapted for any user device. For example, the system described in FIGS. 1-9 may be configured to perform the method 1000 of FIG. 10 to provide a card-based domain search engine interface for a desktop, tablet, or other computing device with a larger screen size, or for a smart watch, eyewear, or other wearable device. Referring to FIGS. 11A-13, another version of an interface 1100 for displaying candidate domain names in a domain search may be optimized for viewing on a smartphone or other mobile device, typically having a touchscreen input. The interface 1100 may use the entirety of the mobile device display, as illustrated, or a portion thereof. The interface 1100 may include a navigation bar 1102, typically at the top or bottom, that includes controls for transitioning to a different user interface or a different part of the interface 1100. The exemplary navigation bar 1102 includes a favorites button 1104 that presents a list of “favorited” candidate domain names, a cart button 1106 that presents the shopping cart interface, and a search refinement box 1108 that allows the user to enter additional terms for refining the search results or to perform a new search.

FIGS. 11A-B illustrate an exemplary “flow” of displays changing in response to interactions on the user interface 1100. The server may first prompt the user to enter one or more domain search terms in a search box 1110 displayed in the interface 1100. The search terms may be a desired domain name or one or more keywords. The server receives the search terms and searches (or instructs another computer to search) one or more registered domain indices. The server may receive an indication that the desired domain name is available, and may transition the interface 1100 to display a card 1112 displaying the desired domain name and a purchase button 1114. The interface 1110 may also include a SERP button 1116 that transitions the interface 1110 to a SERP display, such as that of FIG. 11B.

The interface 1100 in FIG. 11B displays a SERP in which an exact match to the search terms was found. The SERP includes a plurality of cards 1112, 1120, 1122, 1124 representing some or all of the candidate domain names. The cards 1120-24 may display one or more default features common to all cards. A “favorite” icon 1130 may indicate whether the candidate domain name has been added to a stored list of preferred candidate domain names. The interface 1100 may enable the user to add any of the candidate domain names to the favorites list by performing a gesture on the card, such as tapping the icon 1130 or swiping to the right on the card. The server may receive the gesture, add the associated candidate domain name to the favorites list, update metadata for the candidate domain name, and update the display of the card. Unwanted search results may be removed from the list by performing a gesture, such as swiping to the left, on the card. The card may also display a button (e.g., a purchase button 1114, 1140) for initiating the acquisition of the associated candidate domain name.

The card 1112 displaying the exact match may be emphasized in the SERP, such as by displaying the matching card 1112 larger than other cards 1120-24, placing the matching card 1112 at the top of the list of cards, holding the matching card 1112 stationary when a scroll input is received and the other cards are scrolled up or down, and the like.

An instant purchase option may be enabled if the interface 1100 is being displayed to an authorized user. For example, prior to presenting the interface 1100 for domain search, the server can present a login interface allowing the user to access an account. The user's account may be linked to a payment method as is known in the art. With the instant purchase option enabled, a purchase button 1114, 1140 may be displayed on one or more of the cards. When an input is received that selects the purchase button 1114, 1140 on one of the cards, the server may initiate a purchase process for the selected candidate domain name by transitioning the interface 1100 to a purchase confirmation screen, in which the server presents a confirmation prompt 1150. The confirmation prompt 1150 may include essential details of the purchase order—domain name being purchased, price to charge, and payment instrument identifier—as well as a confirm button 1152 to execute the purchase and a cancel button 1154 to cancel the purchase. Responsive to the confirm button 1152 being selected, the server may continue to process the transaction.

When the purchase is complete, the server may transition the interface 1100 back to the SERP and may update the display to show the purchased domain name on a purchased card 1160. In one embodiment, the card may be animatedly flipped over from its previous state to the purchased card state. Elements on a purchased card 1160 may include an indicator that the domain name is owned by the user. When the domain name is a new purchase, the purchased card may include an activate link 1162 that, if selected, causes the server to load a registration interface, a website builder interface, or another interface for activating the newly purchased domain name on the internet.

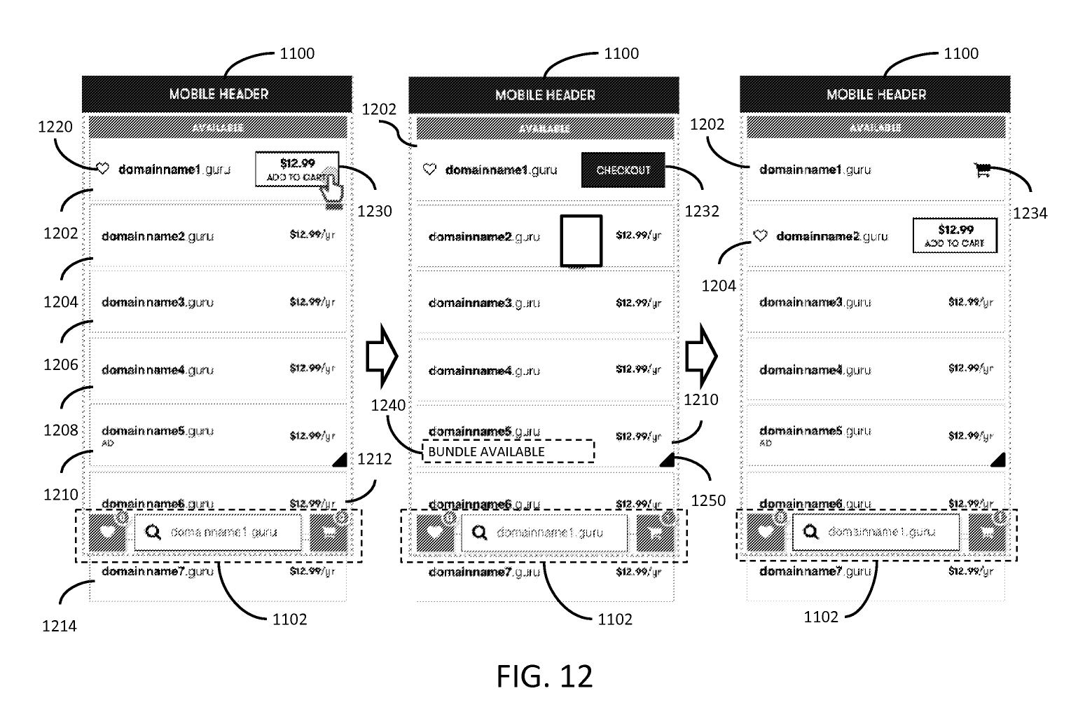

FIG. 12 illustrates an alternate flow of interface 1100 transitions, which may arise when the server does not identify an exact match to the search terms input in the search box 1110 of FIG. 11A. The server may present a SERP comprising a vertically oriented list of substantially equally sized cards 1202-1214 in the interface 1100. As illustrated, the interface 1100 may not be long enough to display all of the cards 1202-1214 at once (see card 1214 being below the display area of the interface 1100 and card 1212 being partially obscured by the navigation bar 1102). A gesture, such as a swipe upward or downward, may scroll the list of cards 1202-1214 across the display area of the interface 1100 in this case.

To conserve space, maintain an uncluttered appearance, and direct attention to the immediately relevant card(s), the interface 1100 may enable the user to “focus” on a particular card in order to examine its features and information. A focus card (card 1202 in the first two illustrated screens) may display its default elements, while the cards 1204-1214 that are not in focus may hide or de-emphasize the displayable elements. For example, the focus card 1202 displays a favorite icon 1220 and an add button 1230 (or purchase button as described above) upon selection, while the other cards only display the price of the candidate domain name and hide the favorite icon 1220 and add button 1230.

The illustrated example interface 1100 may be presented to an anonymous user or a user that does not have a payment instrument linked to her account, or otherwise may be presented when the instant purchase option is disabled. Thus, in contrast to the purchase button 1114, 1140 of FIGS. 11A-B, which initiates a purchase, selecting the add button 1230 may cause the server to add the candidate domain name to an online shopping cart or similar e-commerce purchase platform. Responsive to a selection of the add button 1230 on the focus card 1202, the server may further update the display of the focus card 1202 to show the candidate domain name was added to the cart. The add button 1230 may change to a checkout button 1232 that, when selected, causes the server to load the shopping cart platform to complete the selected purchases. From this state, the server may receive an input indicating a new focus card (card 1204 in the third illustrated screen) is selected. The server may update the display of the new focus card 1204 to show the previously hidden elements, and may update the display of the added card 1202 with an indicator (shopping cart icon 1234) that the candidate domain name is in the shopping cart.

As stated above, one or more of the candidate domain names may be associated with additional attributes that pertain to the user's purchase decision. The interface 1100 may be configured to present some or all of these additional attributes directly in the SERP. However, in order to conserve display area and maintain a consistent appearance, the additional attributes may be partially or fully concealed. A card 1210 may include a marquee 1240, which is a portion of the card 1210 that may be blank if there are no additional attributes to convey, and may include a text descriptor for one or more of the attributes, as is suitable for the space available in the marquee and the information to be conveyed. For example, the descriptor may indicate that the candidate domain name is “premium” or “on sale” or “international” or “recommended.” A card may additionally or alternatively include a tag 1250 for indicating to the user that additional attributes apply and should be reviewed. The tag 1250 may be any suitable graphic placed in a visible location. In response to a selection of the tag 1250, the server may present the additional attributes and/or information pertaining thereto in the interface 1100. The server may present the information in a pop-up prompt, or by opening a new browser window or a new page in a mobile application, by expanding the associated card as described below, or via another suitable presentation.

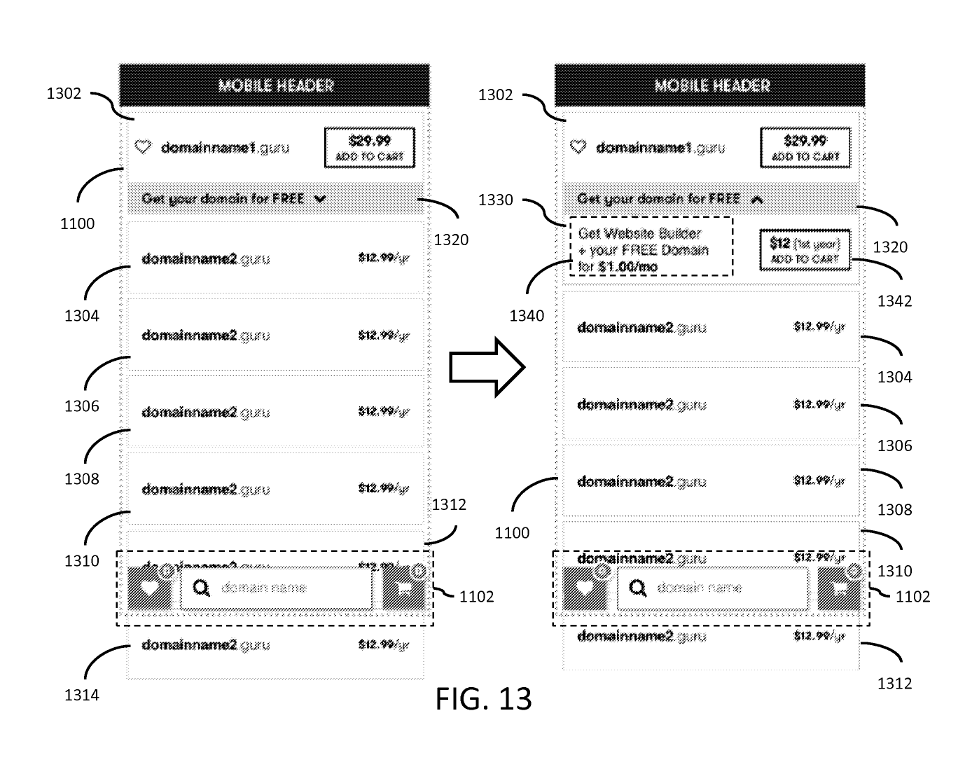

FIG. 13 illustrates an example presentation of the additional attributes of a candidate domain name in the interface 1100. Cards 1302-1314 of a SERP include at least one card 1302 for a candidate domain name that has additional attributes. A tag 1320 also serves as the marquee, presenting a text descriptor and a graphic. Responsive to a gesture on the tag 1320, such as a tap or a swipe downward, the server transitions the interface 1100 to display an expanded card 1302 having a drop-down section 1330 that displays the additional attributes. The drop-down section 1130 may include, for example, one or more text boxes 1340 for conveying the additional attributes, and may further include one or more active regions, such as buttons or links. In the illustrated embodiment, the candidate domain name of the card 1302 includes metadata linking the candidate domain name with additional services that can be purchased at a reduced rate. The text box 1340 presents the offer and the button 1342 is provided for accepting the offer. The cards 1304-1314 below the expanded card 1302 are moved downward in the display to accommodate the expansion.

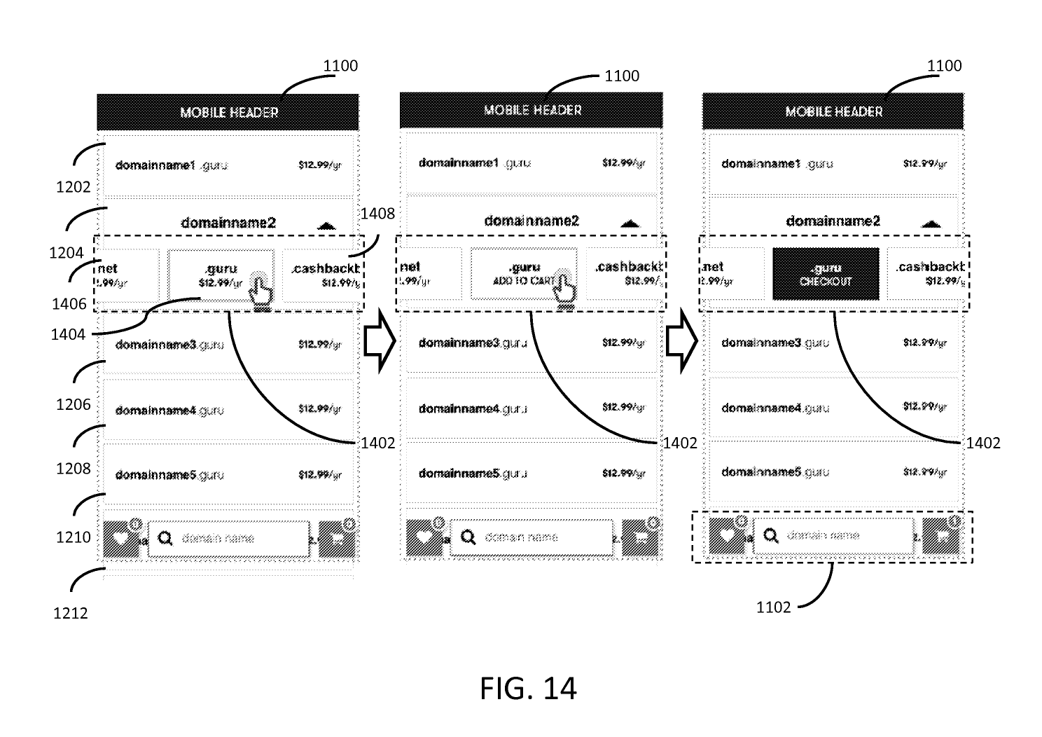

The presently described SERPs, like typical domain name SERPs, are configured to emphasize the different available SLDs in the search results. Any of the SLDs of the candidate domain names may be available with a plurality of TLDs, but for the purpose of presenting the most relevant information, the various TLDs may not be displayed in a default view. FIG. 14 illustrates the interface 1100 of FIG. 12 configured to enable a TLD browser 1402 that presents the various TLDs within the context of the SERP. The illustrated example presumes that the card 1204 is selected as the focus card, as in the third illustrated screen layout of FIG. 12. The server may transition the interface 1100 to display the TLD browser 1402 either automatically upon receiving the selection of the card 1204 as the focus card, or in response to a subsequent input, such as a tap by the user on the displayed domain name. Transitioning the interface 1100 may include expanding the focus card 1204 and moving the cards 1206-1212 downward on the screen layout to accommodate the expanded focus card 1204. The focus card 1204 may then be updated to display the SLD that is selected, or “locked,” and the TLD browser 1402 below the locked SLD.

The TLD browser 1402 may include an add button 1404 for each of the available TLDs. In some embodiments, the interface 1100 may display all of the add buttons 1404 in the layout screen simultaneously. In other embodiments, such as that illustrated, the TLD browser 1402 may have a click-through or scroll-through interface that displays one or more of the add buttons 1404 and is configured to receive an input gesture to change the displayed add buttons 1404. In the illustrated example, the TLD browser 1402 displays an entire add button 1404 and partial add buttons 1406, 1408 that extend off of the left and right edges of the screen layout. The partial add buttons 1406, 1408 indicate to the user that the TLD browser 1402 can be scrolled to the left or right to show additional selectable TLDs. Responsive to an input gesture, such as a swipe left or right on the TLD browser 1402, the server may update the interface 1100 to show the next adjacent add button 1404 in the TLD browser 1402. Selecting one of the add buttons 1404 may cause the candidate domain name to be added to the user's shopping cart as described above with respect to FIG. 12.

The schematic flow chart diagrams included are generally set forth as logical flow-chart diagrams. As such, the depicted order and labeled steps are indicative of one embodiment of the presented method. Other steps and methods may be conceived that are equivalent in function, logic, or effect to one or more steps, or portions thereof, of the illustrated method. Additionally, the format and symbols employed are provided to explain the logical steps of the method and are understood not to limit the scope of the method. Although various arrow types and line types may be employed in the flow-chart diagrams, they are understood not to limit the scope of the corresponding method. Indeed, some arrows or other connectors may be used to indicate only the logical flow of the method. For instance, an arrow may indicate a waiting or monitoring period of unspecified duration between enumerated steps of the depicted method. Additionally, the order in which a particular method occurs may or may not strictly adhere to the order of the corresponding steps shown.

Various embodiments of the invention may be implemented at least in part in any conventional computer programming language. For example, some embodiments may be implemented in a procedural programming language (e.g., “C”, and the like), or in an object oriented programming language (e.g., “C++” “JAVA”, and the like). Other embodiments of the invention may be implemented as preprogrammed hardware elements (e.g., application specific integrated circuits, FPGAs, and digital signal processors), or other related components.

In some embodiments, the disclosed apparatus and methods (e.g., see the various flow charts described above) may be implemented as a computer program product for use with a computer system. Such implementation may include a series of computer instructions fixed either on a tangible medium, such as a computer readable medium (e.g., a diskette, CD-ROM, ROM, or fixed disk) or transmittable to a computer system, via a modem or other interface device, such as a communications adapter connected to a network over a medium.

The medium may be either a tangible medium (e.g., optical or analog communications lines) or a medium implemented with wireless techniques (e.g., WIFI, microwave, infrared or other transmission techniques). The series of computer instructions can embody all or part of the functionality previously described herein with respect to the system.

Those skilled in the art should appreciate that such computer instructions can be written in a number of programming languages for use with many computer architectures or operating systems. Furthermore, such instructions may be stored in any memory device, such as semiconductor, magnetic, optical or other memory devices, and may be transmitted using any communications technology, such as optical, infrared, microwave, or other transmission technologies.

Among other ways, such a computer program product may be distributed as a removable medium with accompanying printed or electronic documentation (e.g., shrink wrapped software), preloaded with a computer system (e.g., on system ROM or fixed disk), or distributed from a server or electronic bulletin board over the network (e.g., the Internet or World Wide Web). Of course, some embodiments of the invention may be implemented as a combination of both software (e.g., a computer program product) and hardware. Still other embodiments of the invention are implemented as entirely hardware, or entirely software.

The present invention has been described in terms of one or more preferred embodiments, and it should be appreciated that many equivalents, alternatives, variations, and modifications, aside from those expressly stated, are possible and within the scope of the invention.

We claim:

1. A method, comprising:
receiving, by a computer server in electronic communication with a computer network, a plurality of candidate domain names identified as search results of a domain name search; and
presenting, by the computer server, to a user via a graphical user interface (GUI) on a display device in electronic communication with the computer network, one or more cards on a screen layout, the cards each comprising a graphical representation of data pertaining to one of the candidate domain names, the GUI enabling the user to perform one or more interactions on the cards.

2. The method of claim 1, wherein the graphical representation of one or more of the cards comprises a front of the card and a back of the card, and wherein one of the interactions comprises enabling the user to flip the card so that the front or the back of the card is displayed.

3. The method of claim 1, wherein the cards each display the candidate domain name to which the card pertains.

4. The method of claim 3, wherein one or more of the cards further display one or more elements of metadata associated with the candidate domain name.

5. The method of claim 4, wherein one of the one or more elements of metadata is a price of the candidate domain name.

6. The method of claim 4, wherein each of the cards comprises one or more hidden elements, wherein the GUI enables a selection of one of the cards as a focus card, and wherein the method further comprises, responsive to the selection of the focus card, updating, by the computer server, the GUI to display one or more of the hidden elements of the focus card, the hidden elements of the other cards remaining hidden.

7. The method of claim 4, wherein one or more of the cards that display metadata further displays a tag selectable by the user, and wherein the method further comprises, responsive to a selection of the tag, updating, by the computer server, the GUI to display additional attributes of the candidate domain name associated with the card displaying the tag.

8. The method of claim 7, wherein the updating the GUI to display additional attributes of the candidate domain name comprises expanding the card displaying the tag to include an expanded portion and displaying the additional attributes in the expanded portion.

9. The method of claim 8, wherein the GUI displays the cards in a vertical list, and wherein expanding the card displaying the tag includes moving the cards below the card displaying the tag downward in the screen layout.

10. The method of claim 1, wherein the GUI displays the cards in a vertical list.

11. The method of claim 10, wherein each of the cards spans the width of the screen layout.

12. The method of claim 1, further comprising:
receiving, by the computer server, interaction data describing a performed interaction of the interactions, the performed interaction involving a first of the one or more cards; and
modifying one or more elements of metadata associated with a first of the candidate domain names, the first candidate domain name being associated with the first card.

13. The method of claim 12, wherein the interaction comprises a selection of a purchase button displayed on the first card, and wherein modifying the one or more elements of metadata associated with the first candidate domain name comprises linking the first candidate domain name with an account of the user.

14. The method of claim 13, further comprising:
responsive to the selection of the purchase button on the first card, updating, by the computer server, the GUI to display a purchase confirmation screen over the one or more cards present on the screen layout, the purchase confirmation screen including a confirm button; and
responsive to a selection of the confirm button, processing, by the computer server, a purchase transaction for the first candidate domain name.

15. The method of claim 1, further comprising:
responsive to a selection of a first of the one or more cards, updating, by the computer server, the GUI to display additional attributes of a first of the candidate domain names, the first candidate domain name being associated with the first card.

16. The method of claim 15, wherein updating the GUI to display additional attributes of the candidate domain name comprises expanding the graphical representation of the first card to include an expanded portion and displaying the additional attributes in the expanded portion.

17. The method of claim 16, wherein the additional attributes comprise a plurality of top-level domains (TLDs) each combinable with an SLD of the first candidate domain name to create one of a plurality of available domain names having the SLD.

18. The method of claim 17, wherein updating the GUI to display the additional attributes comprises displaying a TLD browser in the expanded portion, the TLD browser displaying one or more of the plurality of TLDs and enabling a selection of one of the plurality of TLDs.

19. The method of claim 18, wherein the TLD browser enables the user to scroll through the plurality of TLDs by inputting one or more swipe gestures on the TLD browser.
